(19) United States
(12) Patent Application Publication
(10) Pub. No.: US 2003/0187556 A1
(43) Pub. Date: Oct. 2, 2003

(54) Wheel measuring system, wheel measuring method and wheel-related product sales method

(75) Inventor: Miyoshi Suzuki, Andover (GB)

Correspondence Address: OLIFF & BERRIDGE, PLC, P.O. BOX 19928, ALEXANDRIA, VA, 22320, US

(73) Assignee: Mitutoyo Corporation, Kawasaki-shi (JP)

(21) Appl. No.: 10/385,488

(22) Filed: Mar. 12, 2003

(30) Foreign Application Priority Data
Mar. 27, 2002 (GB) 0207267.6

(51) Int. Cl. G01M 17/013

(52) U.S. Cl. 701/29; 705/1

(57) ABSTRACT

A data processor (13) has a receiver for receiving measurement data on tires (21, 22) attached to an automobile (2) from a tire gauge (11, 12), and a data displaying portion for processing and displaying the received measurement data on a display (326) in a predetermined form. The received measurement data includes pressure value and tread depth of the tires (21, 22). The tread depth is measured on three points of inside, middle and outside in width direction of a tread surface of the tire. The received data is displayed in graphic representing positions of the tires (21, 22) of the automobile (2) and in a graph coloured corresponding to the measurement value.

### BACKGROUND OF THE INVENTION

1. Field of the Invention

The present invention relates to a wheel measuring system, a wheel measuring method and a wheel-related product sales method. More specifically, it relates to a wheel measuring system and a wheel measuring method for measuring and maintaining a wheel and the periphery thereof at a garage, a vehicle parts shop etc. and to a wheel-related product sales method using the measuring system and the measuring method.

2. Description of Related Art

A wheel including a rim, a hub and a tire and the periphery thereof including a brake and a suspension are important for a vehicle.

As mileage of a vehicle increases, pressure change and surface wear of a tire of a wheel are caused, and a brake pad wear of the periphery thereof are inevitable. Status values such as the tire pressure, the tire wear and the pad wear are important as maintenance data of a wheel and the periphery thereof. It is usual that these values are measured on business at institutions such as a vehicle dealer, a maintenance service factory, a garage and a tire shop. It is important for these institutions to maintain the wheel and the periphery thereof as a chance to suggest the end user when the tire needs to be replaced or as a service improvement for the end user. These institutions make a list of the measurement values etc. to consult replacement of the tire or so.

The tire pressure is measured by connecting a pressure gauge with a valve of a tire. State of the tire wear is determined by measuring tread depth by a depth gauge. State of the pad wear is determined by measuring thickness of the brake pad by a calliper. Maintenance data of the other components is measured by existing measuring instruments in accordance with various situations

However, conventional measurement operation of the wheel and the periphery thereof has the following problems.

(1) Generally, the measurement operation of the wheel and the periphery thereof are carried out at each wheel. On the other hand, a report for the user should include all wheel data. Accordingly, it is necessary to repeat measuring each wheel and the periphery thereof and transcribing the measurement values into a record sheet for a plurality of wheels attached to one vehicle and the peripheries thereof, so that it takes a lot of time.

(2) Since the transcribed paper sheet is hard to maintain because of difficulty of search and space required to keep the sheet, the measurement data is manually input into a computer. When the end user requests a maintenance report after the manual data input, it is necessary to re-process the data for the report. Accordingly, it takes furthermore time.

(3) Since the transcription and the manual input are necessary as described above, possibility of human error on the manual transcription cannot be eliminated.

With the above measurement operation, sales activity of a wheel-related product having a wheel including a rim, a hub and a tire, the periphery thereof including a brake pad and brake fluid, and operation including adjusting air pressure, cleaning and adjusting the brake are carried out.

For example, as to tire replacement, an operator judges that tread depth of a tire becomes out of tolerance and selects a suitable tire for the vehicle from a catalogue etc. to suggest replacement to an owner of a vehicle. As to brake pad replacement, after pad wear is measured, the operator similarly suggests replacement to the owner. As to the other components, after measurement by predetermined measuring instruments, the operator similarly suggests replacement to the owner.

However, conventional wheel-related product sales method has the following problems.

(1) Measurement operation for maintenance data on a wheel and the periphery thereof, forecast of maintenance operation timing for the wheel and the periphery thereof on the basis of data obtained by the measurement operation, and selection of recommended maintenance operation for the vehicle based on the forecast are independently carried out. Accordingly, whole operation is inefficient.

(2) Expert knowledge is required to forecast the maintenance operation timing and select the recommended maintenance operation. Accordingly, it takes a lot of time for training an operator.

(3) Possibility of losing business opportunity by wrong forecasting the maintenance operation timing or selecting the maintenance operation cannot be denied.

### SUMMARY OF THE INVENTION

An object of the present invention is to provide a wheel and the periphery thereof measuring system and a measuring method for easily inputting, utilizing and managing maintenance data on a wheel and the periphery thereof such as measurement data of a wheel and the periphery thereof and customer data. Further, another object of the present invention is to provide a wheel-related product sales method for promotion by the measuring system and the measuring method.

A wheel measurement system of the present invention has a wheel gauge having a measurement portion for measuring predetermined maintenance data on a wheel attached to a vehicle and the periphery thereof, and a transmitter for transmitting the measurement data, and a data processor having a receiver for receiving the measurement data from the wheel gauge and a data displaying portion for processing and displaying the received measurement data in a predetermined form.

According to the above arrangement, measurement data can be obtained by the wheel gauge. Further, the measurement data is transmitted from the transmitter to the data processor and processed and displayed by the data processor in a predetermined form. Accordingly, the need of conventional manual data input into a computer can be eliminated.

A data processor of the present invention has a receiver for receiving measurement data of a wheel attached to a vehicle and the periphery thereof from a wheel gauge for measuring predetermined maintenance data of the wheel and the periphery, and a data displaying portion for processing and displaying the received measurement data in a predetermined form.

According to the above arrangement, the data processor can process and display the measurement data received from the wheel gauge in a predetermined form. Accordingly, conventional manual data input into a computer can be eliminated.

In the present invention, the received measurement data may include at least one of pressure value of a tire of the wheel, tread depth of the tire and a pad wear of a brake provided to the periphery of the wheel. In this case, the tread depth of the tire may preferably be measured on at least three points of inside, middle and outside in width direction of a tread surface of the tire.

According to the above arrangement, data to inspect tire surface condition is more precise than an arrangement in which measurement data of tread depth is measured on only one point. Accordingly, the tire surface condition can be inspected more precisely.

In the present invention, the data displaying portion may preferably display a graph coloured corresponding to a selected measurement value.

According to the above arrangement, length and colour of the graph can be changed corresponding to the value of tread depth or brake wear. Accordingly, the tread depth and the brake wear can be easily determined.

In the present invention, the measurement data on the wheel and the periphery may preferably include data on a plurality of wheels of one vehicle and the periphery thereof. Further, the measurement data may preferably include data on a spare tire loaded on the vehicle.

According to the above arrangement, the plurality of the wheels of one vehicle and the peripheries thereof or the plurality of the wheels of one vehicle, the peripheries thereof and a spare tire can be measured together. Accordingly, each wheel and the periphery thereof or each wheel, the periphery thereof and the spare tire can be easily compared, so that operation efficiency can be improved.

In the present invention, the measurement data from the wheel gauge may preferably be transmitted in segment of each wheel or of each wheel and spare tire while the data on the wheel and the periphery or on the wheel, the periphery and the spare tire may preferably be input into the data displaying portion in an order for an operator to move around a vehicle.

According to the above arrangement, work for inputting positions of the wheel or the wheel and the spare tire each time the operator measures each wheel and the periphery thereof or each wheel, the periphery thereof and the spare tire can be omitted. Accordingly, operation efficiency can be improved.

In the present invention, the received measurement data may preferably be displayed in graphic representing positions of the wheels or the wheels and the spare tire in a vehicle.

According to the above arrangement, measurement data of each wheel and the periphery thereof or measurement data of each wheel, the periphery thereof and the spare tire can be displayed in the same relative positions as actual positions of each wheel or each wheel and the spare tire. Accordingly, displayed positions of the measurement data of each wheel and the periphery thereof or that of each wheel, the periphery thereof and the spare tire can be easily identified. In addition, measurement data of each wheel and the periphery thereof or each wheel, the periphery thereof and the spare tire can be easily compared. Accordingly, operation efficiency can be improved.

In the present invention, the receiver may preferably communicate with a plurality of wheel gauges, and the received measurement data may preferably be identified by a transmission identification set to each wheel gauge.

According to the above arrangement, even when the data processor receives measurement data from a plurality of wheel gauges, the data processor can identify which wheel gauge has transmitted the measurement data. Accordingly, interference among the plurality of the wheel gauges can be prevented, so that operation efficiency can be improved.

In the present invention, the received measurement data may preferably be registered in a database including a plurality of measurement records.

According to the above arrangement, the received measurement data can be utilized for maintenance of the wheels and the peripheries thereof in various ways.

In the present invention, each measurement record may preferably be identified by a vehicle registration number and measurement date/time.

According to the above arrangement, a vehicle registration number as principal vehicle identification can be used for identifying data. Accordingly, the database can be easily managed.

In the present invention, the data processor may include a data logger having a receiver for receiving the measurement data from the wheel gauge and temporally storing the received measurement data, and a data storage terminal independent of the data logger for storing the temporally stored measurement data transmitted from the data logger in the database.

According to the above arrangement, measurement data can be logged even at a place away from the data storage terminal.

A wheel measuring method of the present invention includes providing a wheel measurement system including a wheel gauge for measuring predetermined maintenance data on a wheel and the periphery thereof, and a data processor having a receiver for receiving measurement data on the wheel and the periphery and a data displaying portion for processing and displaying the measurement data on the wheel and the periphery in a predetermined form, obtaining the measurement data on a wheel attached to a vehicle and the periphery thereof by an operator using the wheel gauge, transmitting the measurement data from the wheel gauge to the data processor, and processing and displaying the transmitted measurement data by the data processor in a predetermined form.

According to the above method, the measurement data can be processed and displayed in a predetermined form without manual transcription by the operator. Accordingly, operation efficiency can be improved and human error on manual transcription can be eliminated.

In the present invention, the transmitted measurement data may include at least one of pressure value of a tire of the wheel, tread depth of the tire and a pad wear of a brake provided to the periphery of the wheel. In this case, the tread depth of the tire may preferably be measured on at least three points of inside, middle and outside in width direction of a tread surface of the tire.

According to the above method, data to inspect tire surface condition can be more precise than an arrangement in which measurement data of tread depth is measured only on one point. Accordingly, the tire surface condition can be inspected more precisely.

In the present invention, the data displaying portion may preferably display a graph coloured corresponding to a selected measurement value.

According to the above method, length and colour of the graph can be changed corresponding to the value of tread depth or brake wear. Accordingly, the tread depth and the brake wear can be easily determined.

In the present invention, the transmitted measurement data may preferably include data on a plurality of wheels of one vehicle and the periphery thereof. Further, the measurement data may preferably include data on a spare tire loaded on the vehicle.

According to the above method, the measurement data on the plurality of wheels of one vehicle and the peripheries thereof or the plurality of the wheels of one vehicle, the peripheries thereof and a spare tire can be processed and displayed together in a predetermined form. Accordingly, each wheel and the periphery thereof or each wheel, the periphery thereof and the spare tire can be easily compared, so that operation efficiency can be improved.

In the present invention, the wheel measuring method may preferably include transmitting the measurement data from the wheel gauge in segment of each wheel or of each wheel and spare tire, and inputting the transmitted data into the data displaying portion in an order for an operator to move around a vehicle.

According to the above method, work for inputting positions of the wheel and the periphery thereof or the wheel, the periphery thereof and the spare tire each time the operator measures each wheel and the periphery thereof or each wheel, the periphery thereof and the spare tire can be omitted. Accordingly, operation efficiency can be improved.

In the present invention, the wheel measuring method may further include the step of displaying the transmitted measurement data in graphic representing positions of wheels or wheels and a spare tire in a vehicle.

According to the above method, measurement data of each wheel and the periphery thereof or measurement data of each wheel, the periphery thereof and the spare tire can be displayed in the same relative positions as actual positions of each wheel or each wheel and the spare tire. Accordingly, displayed positions of the measurement data of each wheel and the periphery thereof or that of each wheel, the periphery thereof and the spare tire can be easily identified. In addition, measurement data of each wheel and the periphery thereof or each wheel, the periphery thereof and the spare tire can be easily compared. Accordingly, operation efficiency can be improved.

In the present invention, the system may preferably include a plurality of wheel gauges, and the method may preferably include the step of setting transmission identification for each wheel gauge to the measurement data before transmission to identify each transmitted measurement data.

According to the above method, even when the data processor receives measurement data from the plurality of wheel gauges, the data processor can determine which wheel gauge has transmitted the measurement data. Accordingly, the plurality of the wheel gauges can be simultaneously used, so that operation efficiency can be improved.

In the present invention, the wheel measuring method may preferably include the step of storing the transmitted measurement data in a database including a plurality of measurement records.

According to the above method, the received measurement data can be utilized for maintenance of the wheels and the peripheries thereof in various ways.

In the present invention, each transmitted measurement data may preferably be stored as the measurement record, which is identified by a vehicle registration number and measurement date/time.

According to the above method, a vehicle registration number as principal vehicle identification can be used for identifying data. Accordingly, the database can be easily managed.

In the present invention, the data processor may include a data logger and a data storage terminal, the data logger having a receiver for receiving the measurement data from the wheel gauge and temporally storing the transmitted measurement data, and the data storage terminal independent of the data logger for storing the temporally stored measurement data transmitted from the data logger in the database, and the method may further include temporally storing the measurement data from the wheel gauge in the data logger and storing the temporally stored measurement data transmitted from the data logger in the data storage terminal.

According to the above method, measurement data can be logged even at a place away from the data storage terminal.

A program of the present invention enables a computer system to perform the aforesaid wheel measuring methods.

A recording medium of the present invention stores a program for a computer system to perform the aforesaid wheel measuring methods.

The aforesaid wheel measuring methods can be realized and the same effect as the aforesaid wheel measuring system and the data processor can be achieved by running the program in the computer system.

A wheel-related product sales method of the present invention includes setting a database to which predetermined maintenance data on a wheel attached to a vehicle and the periphery thereof is registered in advance, measuring the maintenance data from a wheel of the target vehicle and the periphery thereof to be registered in the database, forecasting maintenance operation timing of the wheel and the periphery on the basis of the measured maintenance data, and selecting and displaying recommended maintenance operation for the vehicle with estimated cost to offer the maintenance operation to the owner of the vehicle.

According to the above method, measurement operation for the maintenance data on the wheel and the periphery thereof, forecast of the maintenance operation timing for the wheel and the periphery thereof on the basis of data obtained by the measurement operation, and selection of recommended maintenance operation for the vehicle are carried out in serial flow. Accordingly, operation efficiency can be improved.

Further, the operator does not have to forecast the maintenance operation timing and select the recommended maintenance operation by its own judgement. Accordingly, the operator does not need to have expert knowledge, so that time for training operator can be reduced.

Furthermore, a human error in forecasting the maintenance operation timing or selecting the recommended maintenance operation can be prevented, so that the business can be smoothly proceeded.

In the present invention, delivery time of the maintenance operation may preferably be displayed in addition to the estimated cost.

According to the above method, the owner of the vehicle can get more information to decide whether or not the recommended maintenance operation should be done. Accordingly, the business can be proceeded more smoothly.

In the present invention, the maintenance data may include replacement timing of a replacement component for the wheel or the periphery thereof and price of the replacement component, and the maintenance operation may be to replace the replacement component.

In the present invention, the wheel may have a tire and the periphery of the wheel may have a brake pad, and the maintenance data may include at least one of air pressure of the tire or the tread depth of the tire or thickness of the brake pad.

In the present invention, maintenance operation timing of the tire may be determined based on the tread depth thereof.

According to the above method, the maintenance operation timing of the tire can be determined based on an objective numerical value.

In the present invention, maintenance operation timing of the brake pad may be determined based on pad wear thereof.

According to the above method, the maintenance operation timing of the brake pad can be determined based on an objective numerical value.

### BRIEF DESCRIPTION OF THE DRAWINGS

FIG. 1 is a schematic diagram of a wheel measuring system 10 of a first embodiment of the present invention;

FIG. 2 is a block diagram of hardware of a data processor 13 of the first embodiment;

FIG. 3 is a conceptual view of data structure of the first embodiment;

FIG. 4 is a schematic diagram of a part of a measurement record 301 of the first embodiment;

FIG. 5 is a schematic diagram of another part of the measurement record 301 of the first embodiment;

FIG. 6 is a schematic diagram of an operator table 310 of the first embodiment;

FIG. 7 is a schematic diagram of a vehicle model table 320 of the first embodiment;

FIG. 8 is a schematic diagram of an age-based vehicle data table 330 of the first embodiment;

FIG. 9 is a schematic diagram of a customer table 340 of the first embodiment;

FIG. 10 is a schematic diagram of a tire model table 350 of the first embodiment;

FIG. 11 is a schematic diagram of a tire history table 360 of the first embodiment;

FIG. 12 is a block diagram of software of a computer 32 of the first embodiment;

FIG. 13 shows a measurement record displaying screen P11 of the first embodiment;

FIG. 14 shows a vehicle code displaying field F111 and a vehicle image displaying field F113 of the first embodiment;

FIG. 15 shows a vehicle/customer data group displaying field F112 of the first embodiment;

FIG. 16 shows a tire data group displaying field F114 of the first embodiment;

FIG. 17 shows a command buttons displaying field F115 of the first embodiment;

FIG. 18 shows a tread depth colouring definition displaying field F116 of the first embodiment;

FIG. 19 shows a vehicle/customer data group input screen P12 of the first embodiment;

FIG. 20 shows a tire data group input screen P13 of the first embodiment;

FIG. 21 shows a measurement data input screen P14 of the first embodiment;

FIG. 22 shows a print preview displaying screen P15 of the first embodiment;

FIG. 23 shows an export executing screen P16 of the first embodiment;

FIG. 24 is a flowchart of operation of the first embodiment;

FIG. 25 is a schematic diagram of a wheel measuring system 50 of a second embodiment of the present invention;

FIG. 26 is a block diagram of hardware of a data logger 56 of the second embodiment;

FIG. 27 is a schematic diagram of a part of a measurement record 301A of the second embodiment;

FIG. 28 is a schematic diagram of another part of the measurement record 301A of the second embodiment;

FIG. 29 is a block diagram of software of a PDA 62 of the second embodiment;

FIG. 30 shows a measurement record list displaying screen P21 of the data logger 56 of the second embodiment;

FIG. 31 shows a tire position block diagram displaying screen P22 of the data logger 56 of the second embodiment;

FIG. 32 shows a tire data group input screen P23 of the data logger 56 of the second embodiment;

FIG. 33 is a block diagram of software of a computer 72 of the second embodiment;

FIG. 34 shows a measurement record displaying field P31 of a data storage terminal 57 of the second embodiment;

FIG. 35 shows a vehicle/customer data group displaying field F312 of the second embodiment;

FIG. 36 shows a vehicle code displaying field F311 and a vehicle image displaying field F113 of the second embodiment;

FIG. 37 shows tire data group displaying fields F114 of the second embodiment;

FIG. 38 shows an axle configuration selecting field F315 of the second embodiment;

FIG. 39 is a flowchart of operation of the second embodiment;

FIG. 40 shows a replacement tire list displaying screen P87 of a third embodiment of the present invention; and

FIG. 41 shows a replacement tire list 880 of the third embodiment.

### DETAILED DESCRIPTION OF PREFERRED EMBODIMENT(S)

Each embodiment of the present invention will be described below with reference to the drawings. Incidentally, same reference numbers are allotted to similar functions and arrangements in each embodiment.

[First Embodiment]

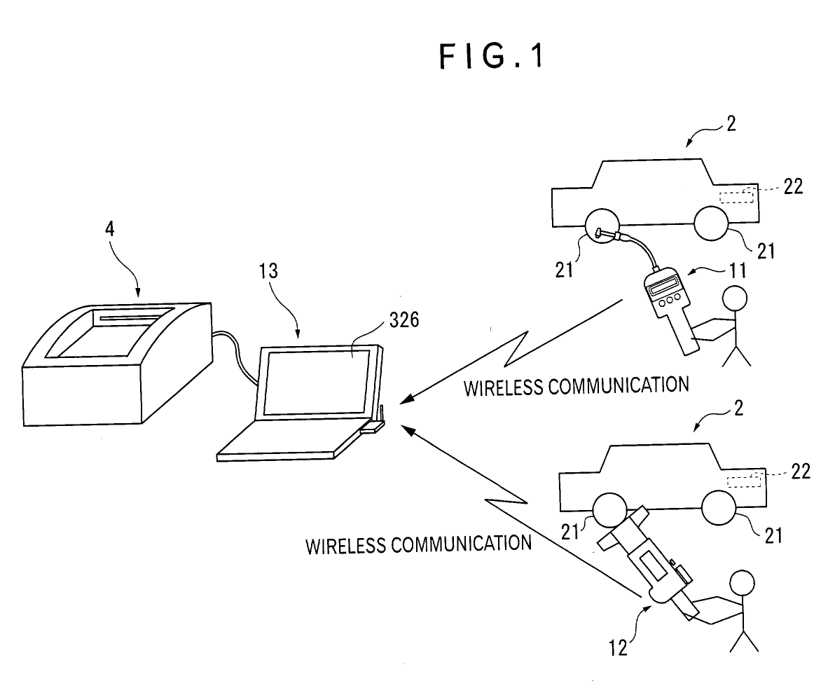

A wheel measuring system 10 of the present embodiment is installed in a vehicle maintenance shop, a vehicle dealer, a vehicle parts shop including maintenance and replacement service etc., and carries out various measurement for maintenance of a wheel of a vehicle and the periphery thereof. More specifically, as shown in FIG. 1, the system 10 has a pressure gauge 11 for measuring air pressure of tires 21 and 22 of automobiles 2, a depth gauge 12 for measuring tread depth of the tires 21 and 22, and a data processor 13 for receiving data measured by the pressure gauge 11 and the depth gauge 12 and processing the data.

The automobiles 2 as the measurement object have four tires 21 respectively attached to the front right, the front left, the back right and the back left of the automobiles 2 and one spare tire 22.

The pressure gauge 11 has a pressure sensor for measuring pressure of the tires 21 and 22, and a data transmitter for transmitting the measurement data to the data processor 13 by wireless.

The depth gauge 12 has a depth measuring instrument for measuring the depth of the tires 21 and 22, and a data transmitter for transmitting the measurement data to the data processor 13 by wireless.

Since any existing pressure sensor, any existing depth measuring instrument and any existing data transmitter can be used for the pressure gauge 11 and the depth gauge 12, details of the pressure sensor, the depth measuring instrument and the transmitter will be omitted. The pressure gauge 11 and the depth gauge 12 have different transmission ID (transmission identification) and transmit each measurement data with transmission ID thereof.

The data processor 13 combines vehicles/customers data separately input with each received data to configure a database, displays each data transmitted from the pressure gauge 11 and the depth gauge 12 on a display 326, processes and outputs each data to a colour printer 4.

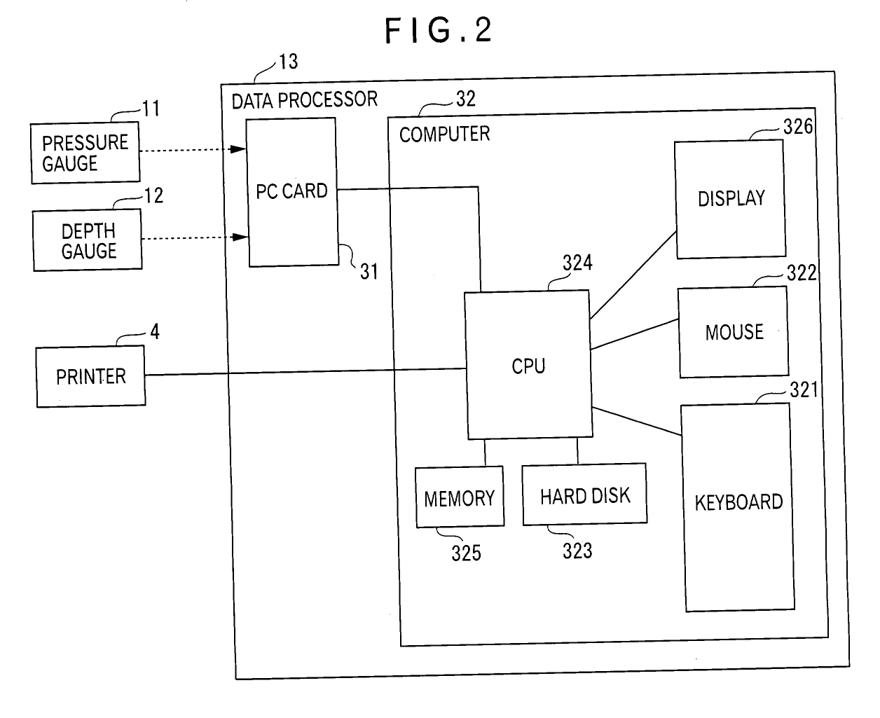

FIG. 2 shows a block diagram of hardware of the data processor 13 of the present embodiment.

The data processor 13 of the present embodiment consists of a notebook computer 32, into which a PC card (PCMCIA standard card) 31 for receiving data from the pressure gauge 11 and the depth gauge 12 is inserted.

The computer 32 processes each received measurement data and has a keyboard 321, a mouse 322, a hard disk 323, a CPU (central processing unit) 324, a memory 325 and the display 326.

A data processing program DP run by the CPU 324 performs various data processing in the computer 32.

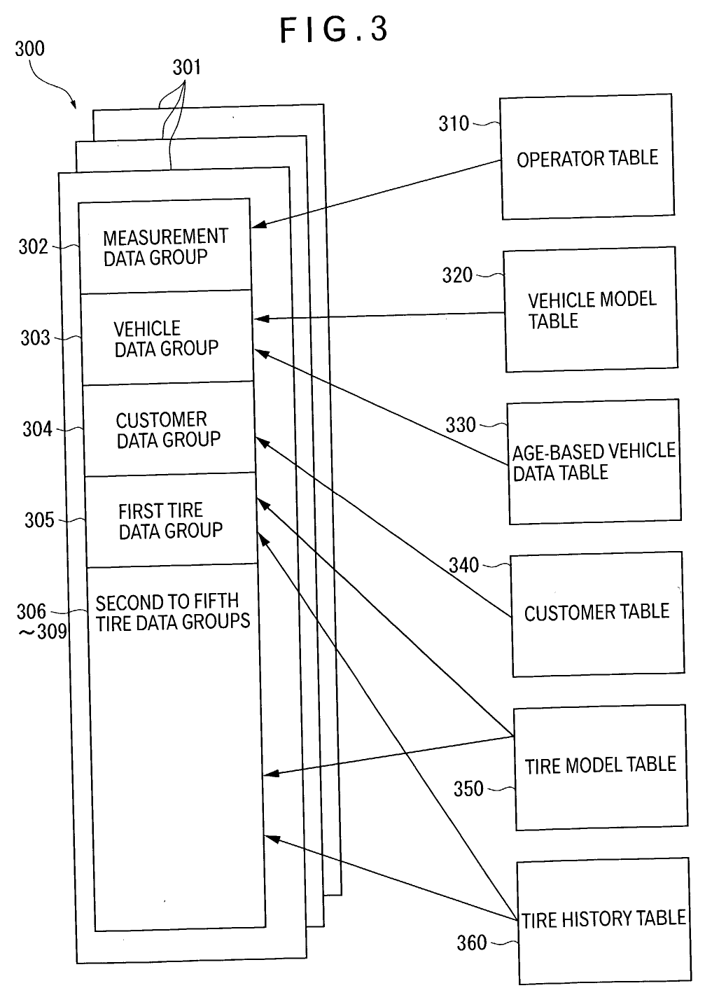

FIG. 3 shows a conceptual data structure of the present embodiment.

A database D of the present embodiment includes a basic table 300 having a plurality of measurement records 301 identified with a vehicle number and measurement data, an operator table 310 having data identified with each operator, a vehicle model table 320 having data on vehicles such as a manufacturer and a vehicle's name, an age-based vehicle data table 330 having age-based data on vehicles, a customer table 340 having data on customers, a tire model table 350 having data on tires such as a manufacturer and a model, and a tire history table 360 having age-based data on tires.

Each measurement table 301 includes a measurement data group 302 having data on measurement situations, a vehicle data group 303 having data on vehicles, a customer data group 304 having data on customers, first to fifth tire data groups 305 to 309 having data on each tire. Each data group 302 to 309 refers to each table 310 to 360 for common information.

Data in each table 310 to 360 can be edited and each edited data is reflected to each data group 302 to 309.

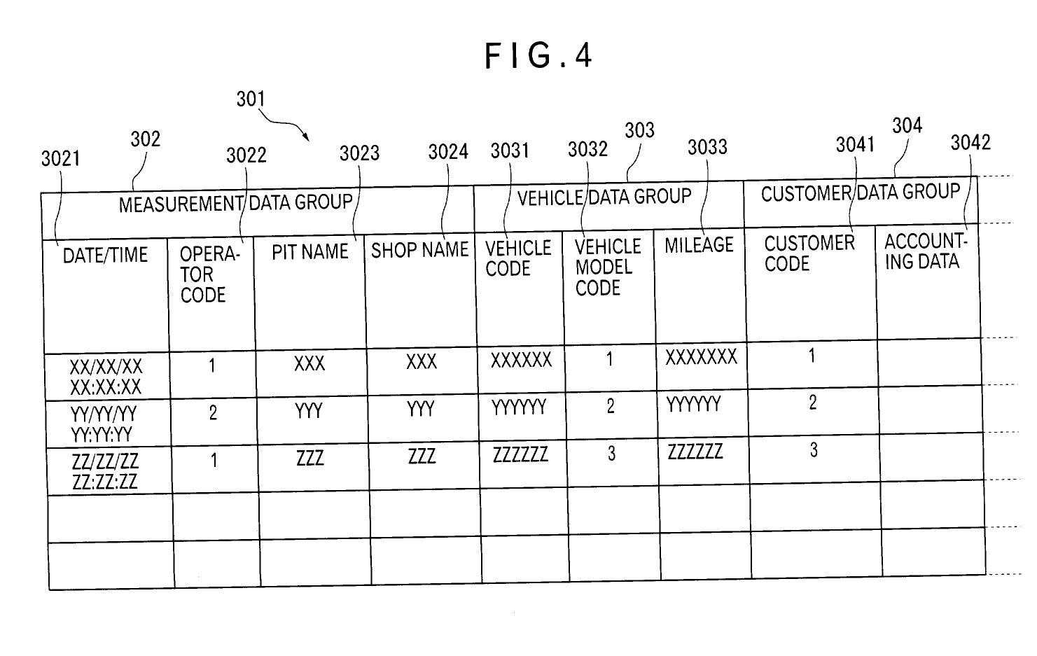

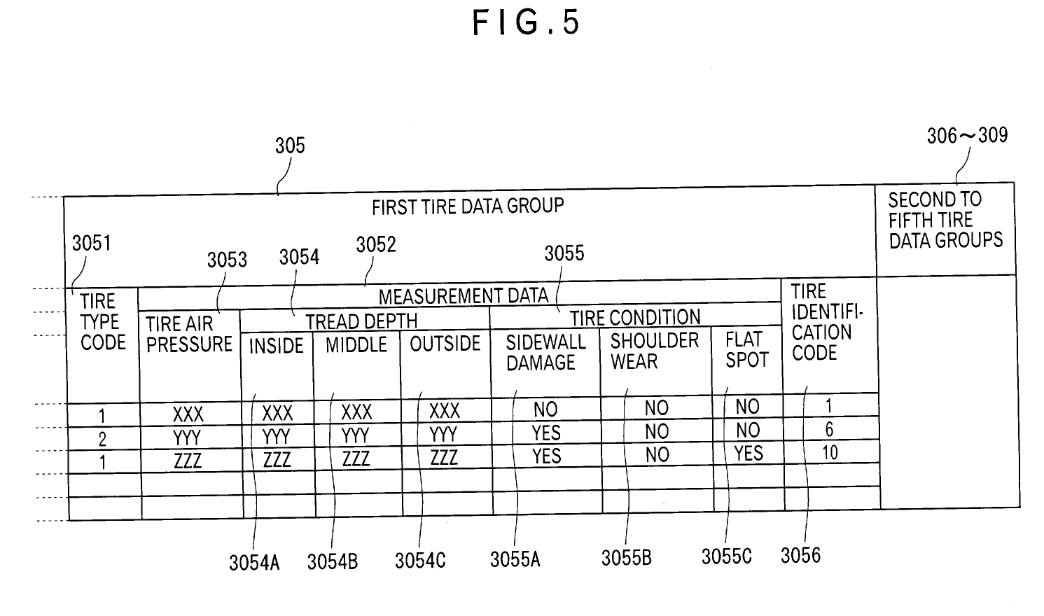

FIG. 4 and FIG. 5 show a specific arrangement of the measurement record 301 of the present embodiment.

The measurement data group 302 in the measurement record 301 includes a measurement data/time 3021 having date and time when the measurement data is registered, a operator code 3022 conveniently allotted to each measuring operator, a pit name 3023 where the measurement is carried out, and a shop name 3024 where the measurement is carried out.

The vehicle data group 303 includes a vehicle code 3031 having a vehicle registration number displayed on the registration plate of the automobile 2, a vehicle model code 3032 conveniently allotted to each set of a manufacturer, a vehicle's name, a model and a specification of a vehicle, and a mileage 3033 representing mileage in measuring.

The customer data group 304 includes a customer code 3041 conveniently allotted to each customer and an accounting data 3042 for registering an account when charged to the customer.

The first tire data group 305 includes a tire model code 3051 conveniently allotted to each set of a manufacturer, a model, width, size, rate, speed and type of a tire, a measurement data 3052 having a tire air pressure 3053, a tire tread depth 3054 and a tire condition 3055, and a tire identifying code 3056 conveniently allotted to each tire.

The tread depth 3054 includes an inside tread depth 3054A representing an inside tread depth of a tire, a middle tread depth 3054B representing a middle tread depth of the tire and an outside tread depth 3054C representing an outside tread depth of the tire.

The tire condition 3055 includes a sidewall damage 3055A, a shoulder wear 3055B and a flat spot 3055C, all of them representing damage degree of tire.

Since arrangements of the second to the fifth tire data groups 306 to 309 are similar with the arrangement of the first tire data group 305, the structures of the tire data groups 306 to 309 will not be specifically described.

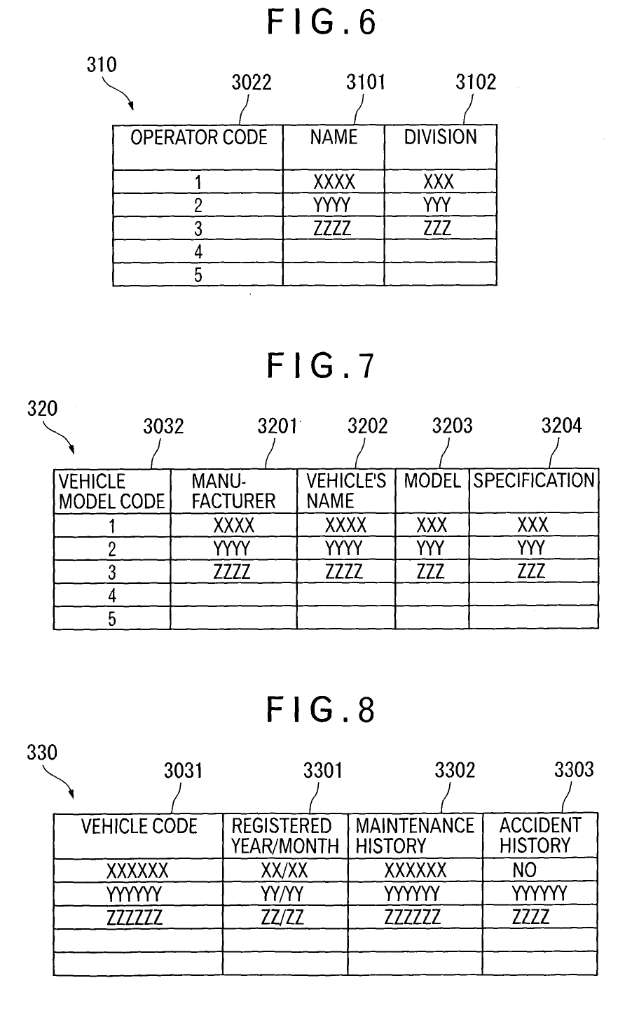

FIG. 6 shows a specific arrangement of the operator table 310 of the present embodiment.

The operator table 310 includes an operator code 3022 conveniently allotted to each measuring operator, an operator's name 3101 and a division 3102 representing a division that the measuring operator belongs to.

FIG. 7 shows a specific arrangement of the vehicle model table 320 of the present embodiment.

The vehicle model table 320 includes a vehicle model code 3032 conveniently allotted to each set of a manufacturer, a vehicle's name, a model and a specification of a vehicle, a manufacturer 3201 of each vehicle, a vehicle's name 3202 representing each vehicle's commercial name, a model 3203 of each vehicle and a specification 3204 of each vehicle.

FIG. 8 shows a specific arrangement of the age-based vehicle data table 330 of the present embodiment.

The age-based vehicle data table 330 includes a vehicle code 3031 having a vehicle registration number displayed on each registration plate of the automobiles 2, a register year/month 3301 representing a year and a month when a vehicle is registered, a maintenance history 3302 representing history of maintenance of each vehicle, and a accident history 3303 representing accident history of each vehicle.

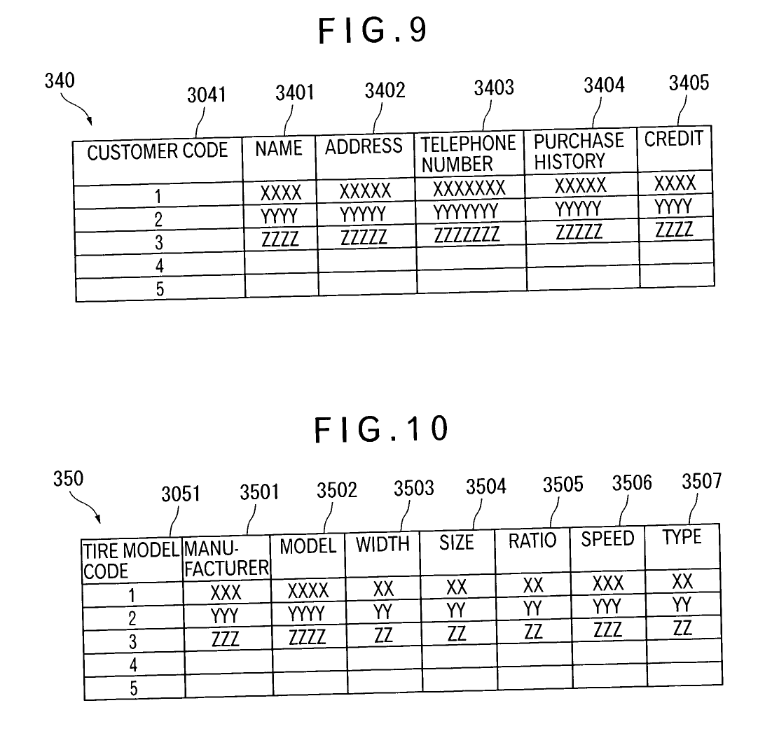

FIG. 9 shows a specific arrangement of the customer table 340 of the present embodiment.

The customer table 340 includes a customer code 3041 conveniently allotted to each customer, a customer's name 3401, a customer's address 3402, a customer's telephone number 3403, a purchase history 3404 of vehicle components of each customer, and a credit 3405 representing a credit status of each customer.

FIG. 10 shows a specific arrangement of the tire model table 350 of the present embodiment.

The tire model table 350 includes a tire model code 3051 conveniently allotted to each set of a manufacturer, a model, width, size, rate, speed and type of a tire, a manufacturer 3501 of each tire, a model 3501 of each tire, a width 3503 of each tire, a size 3504 representing a diameter of each tire, a rate 3505 of each tire, a speed 3506 of each tire, and a type 3507 representing tire types such as winter tire.

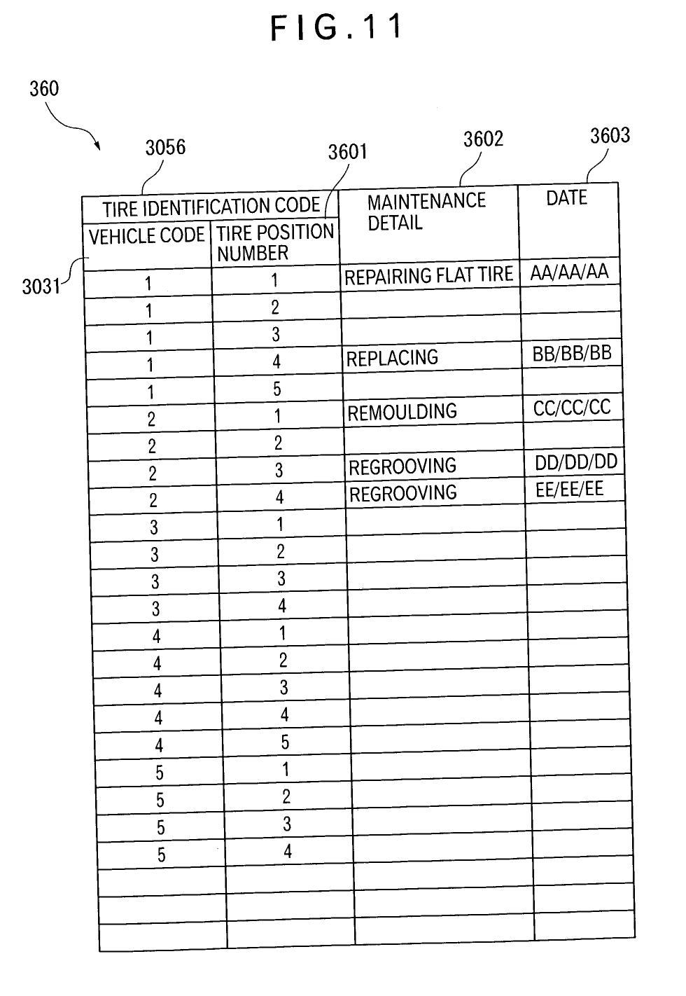

FIG. 11 shows a specific arrangement of the tire history table 360 of the present embodiment.

The tire history table 360 includes the tire identifying code 3056, a maintenance detail 3602 and a maintenance date 3603. The tire identifying code 3056 is conveniently allotted to each tire and has the vehicle code 3031 and a tire number 3601 representing a position of each tire. The maintenance detail 3602 represents tire maintenance detail such as repairing a flat tire, remoulding and regrooving. The maintenance date 3603 represents a date when the maintenance is carried out.

The database D of the present embodiment has a plurality of the aforesaid tables. Each table is related as follows.

Specifically, the operator table 310 is referred to by using the operator code 3022 as a key cord when the measurement data is displayed in the measurement record 301. Then, the operator's name 3101 is read out from the corresponding record and displayed as a measuring operator measuring a target vehicle.

The vehicle model table 320 is referred to by using the vehicle model code 3032 as a key code. Then, the vehicle's name 3202 and the model 3203 are read out from the corresponding record and displayed as a vehicle's name and a model of a target vehicle.

The age-based vehicle data table 330 is referred to by using the vehicle code 3031 as a key code. The register year/month 3301, the maintenance history 3302 and the accident history 3303 are read out from the corresponding record and displayed as age-based data of a target vehicle.

The customer table 340 is referred to by using the customer code 3041 as a key code. Then, the customer's name 3401, the address 3402 and the telephone number 3403 are read out from the corresponding record and displayed as a data of a target vehicle.

The tire model table 350 is referred to by using the tire model code 3051 as a key code. Then, the manufacturer 3501, the model 3502, the width 3503, the size 3504, the rate 3505, the speed 3506 and the type 3507 are read out from the corresponding record and displayed as data of a target tire.

The tire history table 360 is referred to by using the tire identifying code 3056 as a key code. Then, the maintenance detail 3602 and the maintenance date 3603 are read out from the corresponding record and displayed as maintenance detail and maintenance date of a target tire.

While the above database D is used, the following various data processing is performed in the present embodiment.

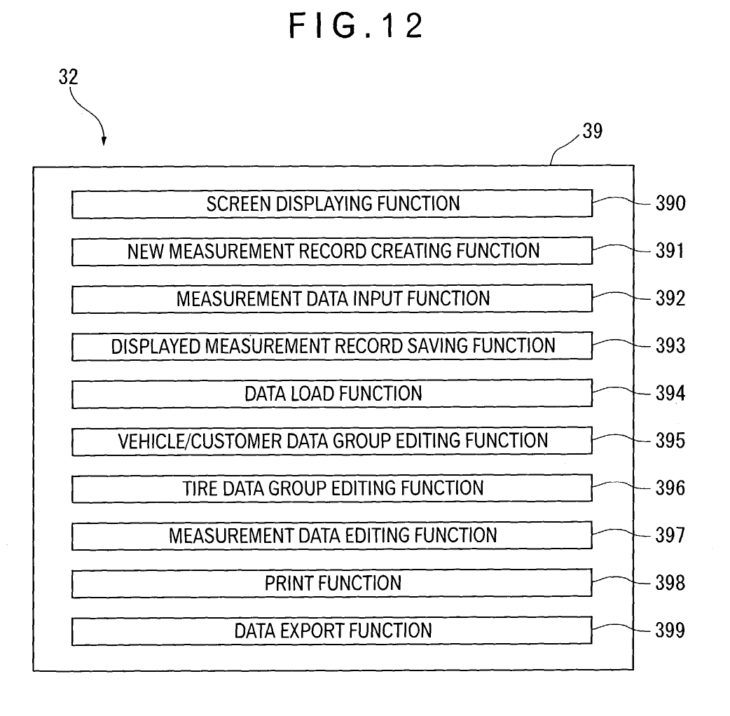

As shown in FIG. 12, a data processing part 39 is loaded on the computer 32 of the present embodiment by software.

The data processing part 39 has a screen displaying function 390, a new measurement record creating function 391, a measurement data input function 392, a displayed measurement record saving function 393, a data load function 394, a vehicle/customer data group editing function 395, a tire data group editing function 396, a measurement data editing function 397, a print function 398 and a data export function 399.

These functions 390 to 399 are performed by the CPU 324 running a data processing program DP registered in the hard disk 323.

The screen displaying function 390 displays some screens on the display 326 under the functions 391 to 399 performed. The displayed screens are used to input various data or commanding operation to utilize the database D.

The screen displaying function 390 has a measurement record displaying screen P11, a vehicle/customer data group input screen P12, a tire data group input screen P13, a measurement data input screen P14, a print preview displaying screen P15 and a data export executing screen P16. These screens will be described below.

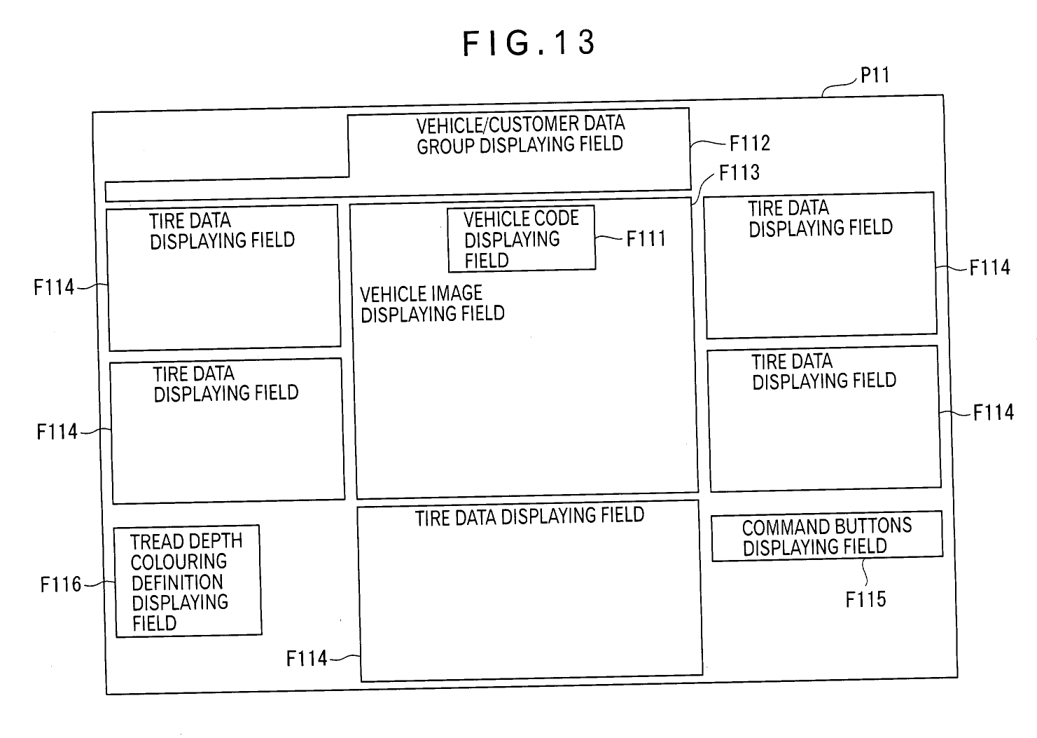

FIG. 13 shows the measurement record displaying screen P11 for displaying the measurement record 301.

The screen P11 includes a vehicle code displaying field F111, a vehicle/customer data group displaying field F112, a vehicle image displaying field F113, tire data group displaying fields F114, a command buttons displaying field F115, and a tread depth colouring definition displaying field F116.

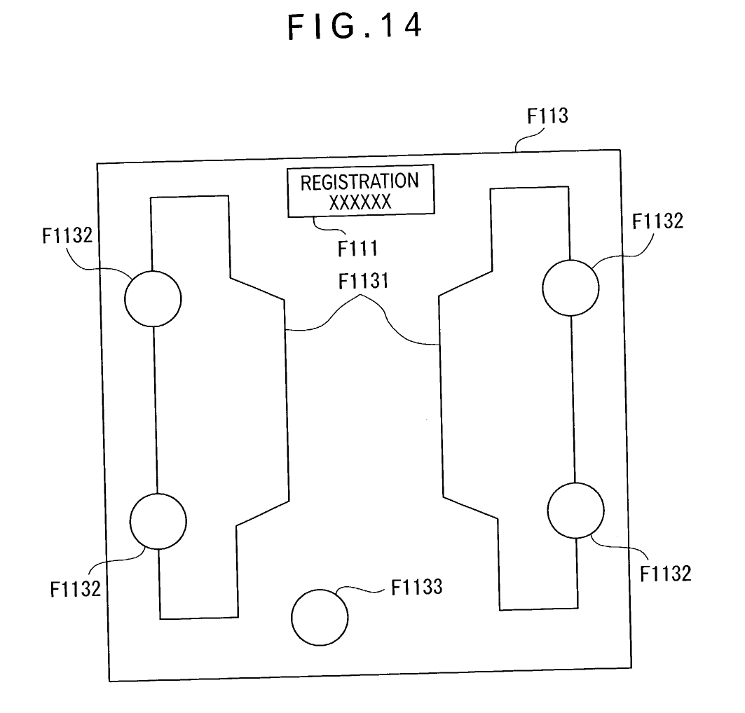

The field F111 is displayed in the upper middle of the screen and used to input and display the vehicle code 3031 as shown in FIG. 14.

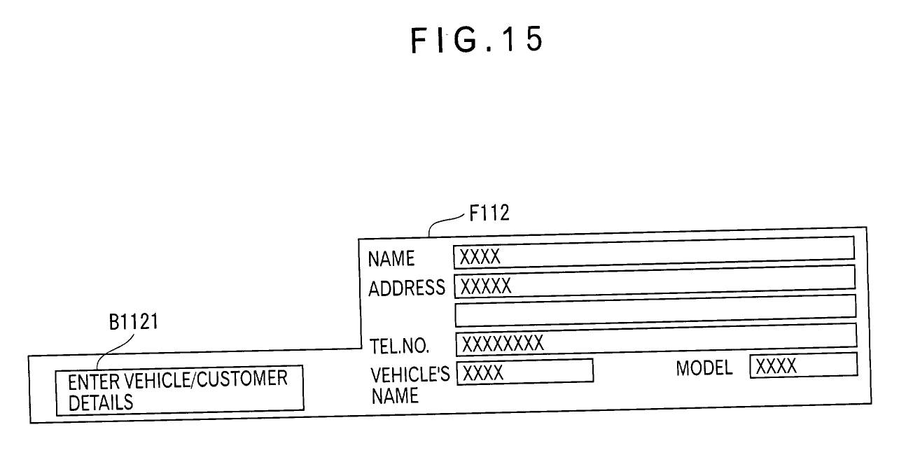

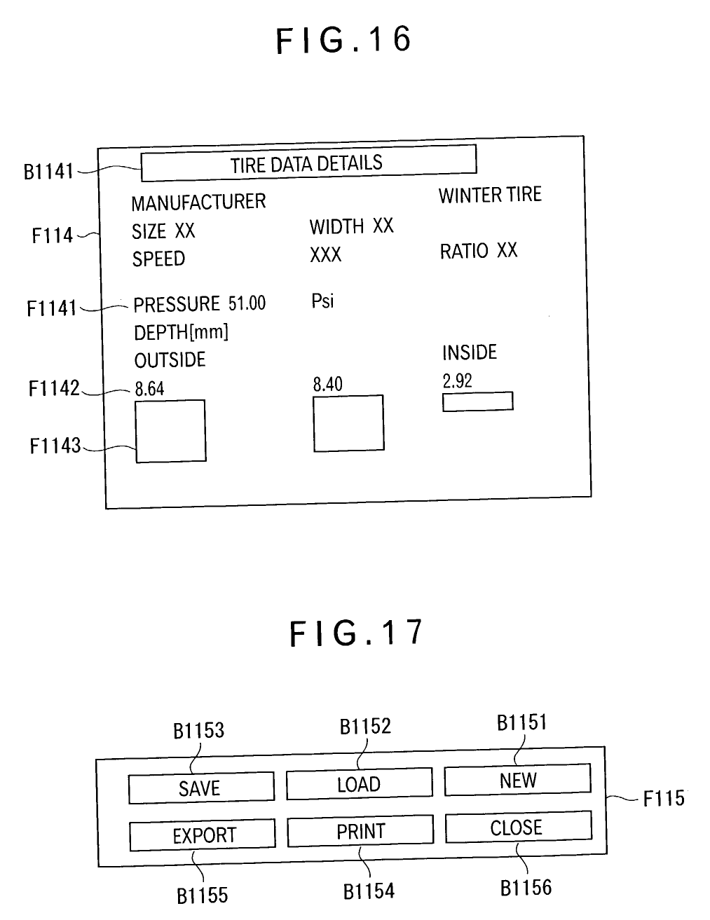

The field F112 is displayed from the upper middle to the upper left of the screen and used for displaying a vehicle's name and a model as the vehicle data group 303, a customer's name, the customer's address and the customer's telephone number as the customer data group 304, and a vehicle/customer data group editing button B1121 to display the vehicle/customer data group input screen P12 as shown in FIG. 15.

The field F113 is displayed in the centre of the screen and used for displaying a vehicle image F1131, left and right side tire images F1132 and a spare tire image F1133 as shown in FIG. 14.

The fields F114 are displayed at five positions, which are on the middle right, on the middle left and in the lower middle of the screen in accordance with the positions of each tire image F1132 and F1133 of the vehicle image displaying field F113. Each field F114 has a field for displaying a manufacturer, type, size, width, speed, rate, tire pressure value F1141, tread depth (inside, middle, outside) F1142, bar graphs F1143 corresponding to each tread depth, and a tire data group editing button B1141 to execute the tire data group editing function 396.

The tread depth near to the vehicle image displaying field F113 represents an inner tread depth of a tire.

Each tire pressure value F1141 and tread depth (inside, middle, outside) F1142 works also as a button to execute the measurement data input function 392 and the measurement data editing function 397.

A pointer is displayed on the pressure value F1141 or the tread depth (inside, middle, outside) F1142 of the target tire when the measurement data input function 392 is executing.

Each bar graph F1143 represents each tread depth and predetermined safety range, caution range and danger range of the tread depth by colouring each bar graph F1143. Not shown in the figure, the safety range is, for example, green, the caution range is yellow, and the danger range is red.

The command buttons displaying field F115 is displayed on the lower right of the screen and has a new record creating button F1151, a load button B1152, a save button B1153, a print preview displaying button B1154, an export destination specifying button B1155 and a close button B1156 as shown in FIG. 17.

The new record creating button B1151 is used to execute the new measurement record creating function 391.

The load button B1152 is used to execute the data load function 394.

The save button B1153 is used to execute the displayed measurement record saving function 393.

The print preview displaying button B1154 is used to execute the print function 398.

The export destination specifying button B1155 is used to execute the data export function 399.

The close button B1156 is used to close the data processing program DP.

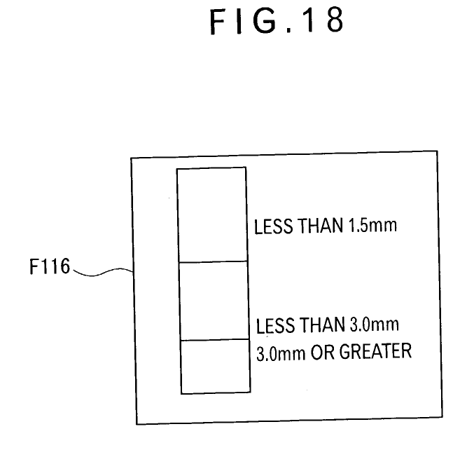

The tread depth colouring definition displaying field F116 is displayed on the lower left of the screen and expresses predetermined safety range, caution range and danger range of the tread depth by displaying numbers and colouring these ranges as shown in FIG. 18. Not shown in the figure, the safety range is, for example, green, the caution range is yellow, and the danger range is red.

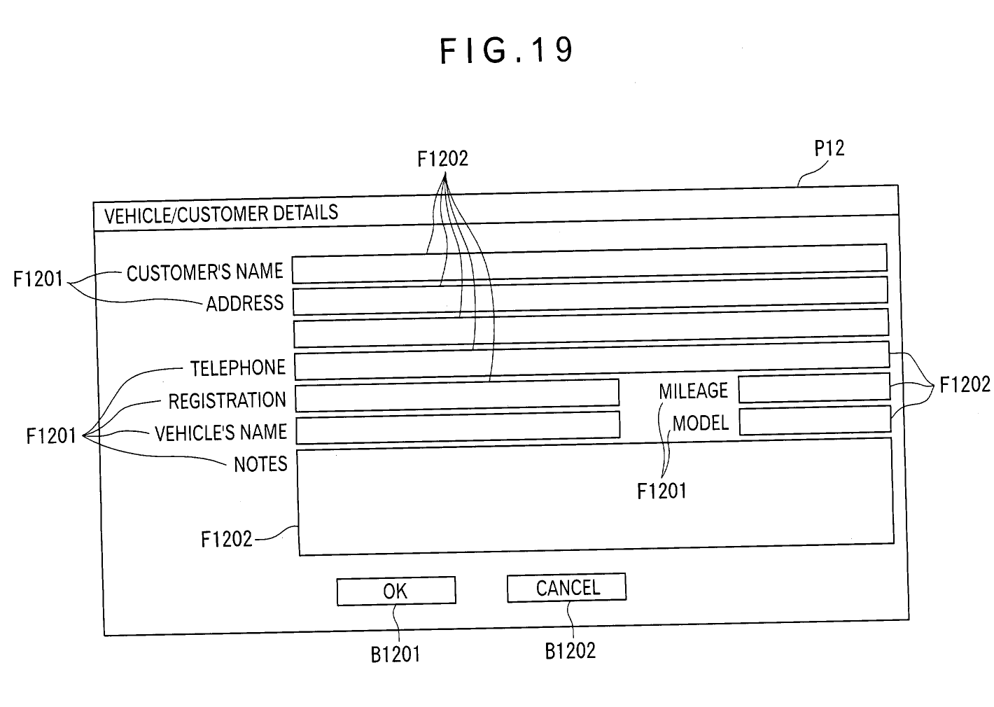

FIG. 19 shows the vehicle/customer data group input screen P12 to input and edit the vehicle data group 303 and the customer data group 304.

The screen P12 has a vehicle/customer data group displaying field F1201, a vehicle/customer data group input field F1202, an OK button B1201, and a cancel button B1202.

The field F1201 is used to display a customer's name, a customer's address, a customer's telephone number, a vehicle code, mileage, a vehicle's name, the vehicle's model and a reference as the vehicle data group 303 and the customer data group 304. The field F1202 is used to input the vehicle data group 303 and the customer data group 304. The OK button B1201 is used to proceed to the next step. The cancel button B1202 is used to cancel the process.

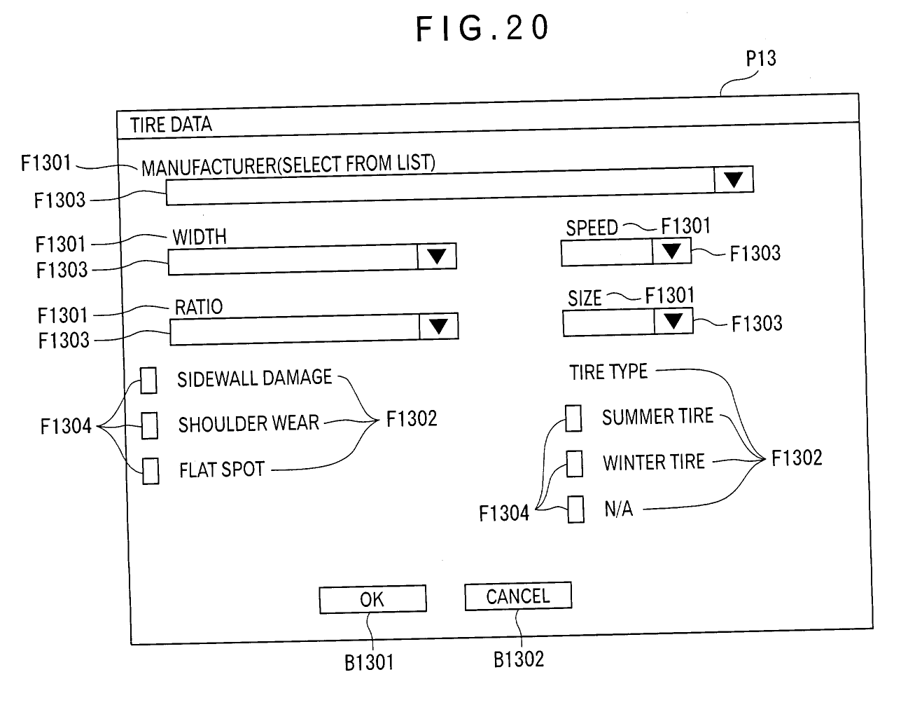

FIG. 20 shows the tire data group input screen P13 to input and edit the first to the fifth tire data groups 305 to 309.

The screen P13 has tire data group displaying fields F1301 and F1302, tire data group input fields F1303 and F1304, an OK button B1301, and a cancel button B1302.

The field F1301 is used to display a manufacturer, width, speed, rate, and size of each tire data group 305 to 309. The field F1302 is used to display sidewall damage, shoulder wear, flat spot and tire type (summer tire, winter tire, N/A (not applicable)) of each tire data group 305 to 309. The field F1303 is used to input data on items displayed in the tire data group displaying field F1301. The tire data group input field F1304 is used to input data on items displayed in the tire data group displaying field F1302. The OK button B1301 is used to proceed to the next step. The cancel button B1302 is used to cancel the process.

Incidentally, the field F1303 can also be input by drop menu. The field F1304 can also be input by a check box.

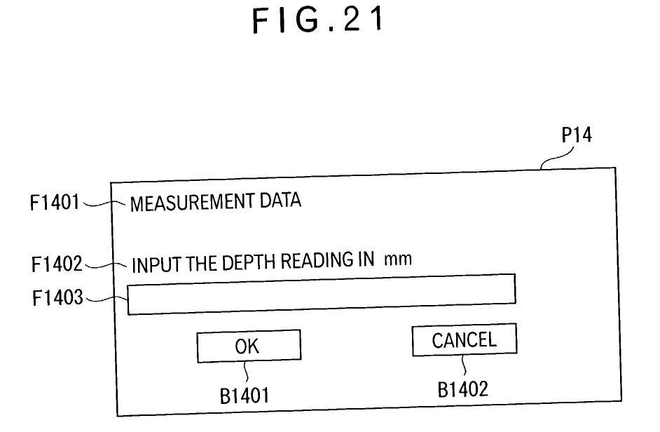

FIG. 21 shows the measurement data input screen P14 to input and edit the measurement data.

The screen P14 has a measurement data displaying field F1401, a measurement data input message F1402, a measurement data input field F1403, an OK button B1401, and a cancel button B1402.

The field F1401 displays characters of “MEASUREMENT DATA”. The message F1402 displays a message of “INPUT MEASUREMENT DATA”. The field F1403 is used to input the measurement data. The OK button B1401 is used to proceed to the next stage. The cancel button B1402 is used to cancel the process.

Incidentally, the message F1402 in FIG. 21 is used in measuring the tread depth, and displays “INPUT PRESSURE VALUE (PSI)” in measuring the pressure.

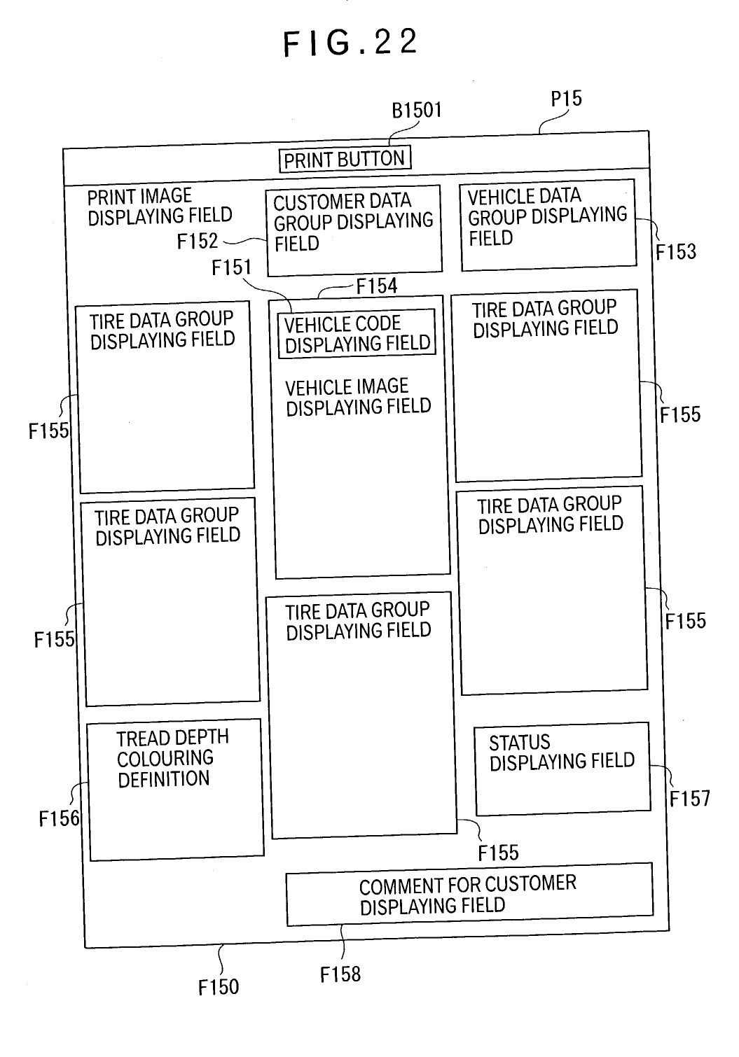

FIG. 22 shows the print preview displaying screen P15 for displaying a print preview.

The screen P15 has a print image displaying field F150 and a print button B1501. The field F150 includes a vehicle code displaying field F151, a customer data group displaying field F152, a vehicle data group displaying field F153, a vehicle image displaying field F154, tire data group displaying fields F155, a tread depth colouring definition displaying field F156, a status displaying field F157, and a comment for customer displaying field F158.

Since the fields F151, F154, F155 and F156 are similar with the fields F111, F113, F114 and F116 respectively, specific description will be omitted.

The field F152 is displayed in the upper middle of the screen and used for displaying a customer's name, the customer's address, and the customer's telephone number as the customer data group 304.

The field F153 is displayed on the upper right of the screen and used for displaying a vehicle's name, the vehicle's model and mileage as the vehicle data group 303 and a current date.

The field F157 is used to input and display data in accordance with pressure value and tread depth of each tire (status information).

The field F158 is used to input and display a promotion comment based on the status data (comment for customer).

The print button B1501 is displayed in the upper middle and used to print the print image displaying field F150.

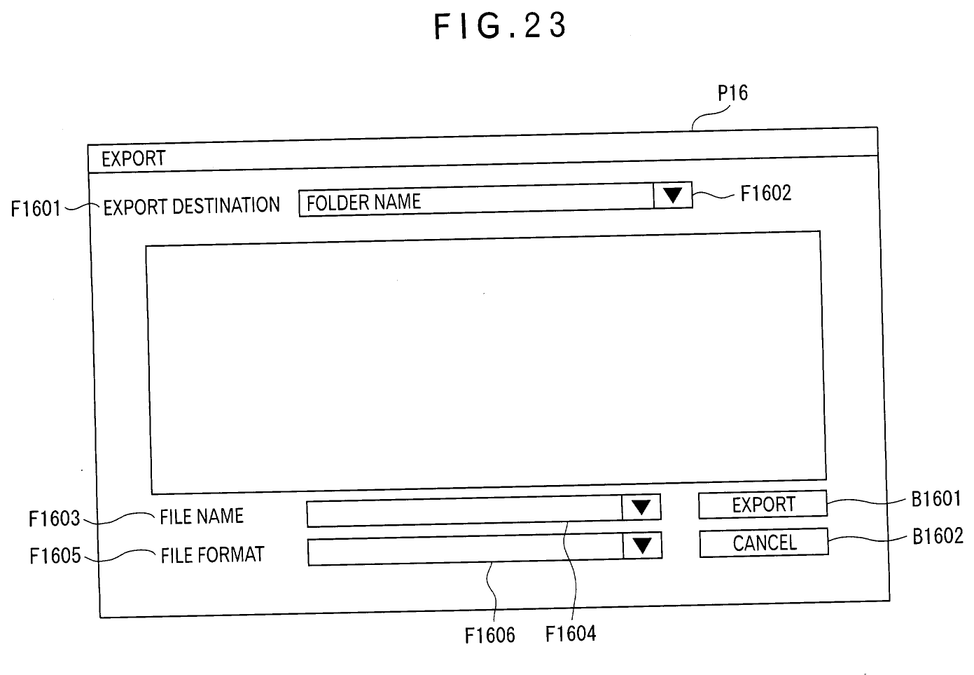

FIG. 23 shows the export executing screen P16 to execute data export function.

The screen P16 has an export destination specifying field F1601, an export destination input field F1602, a file name displaying field F1603, a file name input field F1604, a file format displaying field F1605, a file format input field F1606, an export button B1601 to export, and a cancel button B1602 to cancel the export.

Incidentally, the fields F1602, F1604 and F1606 can also be input by drop menu.

The aforesaid screens P11 to P16 are used to perform the following functions 391 to 399 by the data processor 13.

(1) New Measurement Record Creating Function 391

This function is used to create a new measurement record 301.

The function 391 is performed based on the following process.

When the new record creating button B1151 is clicked in the measurement record displaying screen P11, the vehicle/customer data group input screen P12 is displayed, overlapping with the screen P11.

When the vehicle data group 303 and the customer data group 304 are input into the vehicle/customer data group input field F1202 on the screen P12, the input data is displayed on the field F1202. When the OK button B1201 is clicked, the input data is temporally registered in the memory 325. Then, the tire data group input screen P13 is displayed, overlapping with the screen P11. Incidentally, when the cancel button B1202 is clicked, the process is terminated at the stage and the screen P11 is displayed.

When the tire data group is input into the tire data group input fields F1303 and F1304 on the screen P13, the input data is displayed in the fields F1303 and F1304. When the OK button B1301 is clicked, the screen P11 reflecting the input data and the input vehicle/customer data group is displayed. The input data on the tire data group is reflected in all tire data group displaying fields F114. Incidentally, when the cancel button B1302 is clicked, the process is terminated at the stage and the screen P12 is displayed.

(2) Measurement Data Input Function 392

This function is used to input measurement data of each tire data group 305 to 309.

The function 392 is performed based on the following process.

When the pressure value F1141 or the tread depth F1142 of any one of tire data group displaying fields F114 is clicked twice by the mouse 322 on the screen P11, the screen P14 for the pressure value or the tread depth is displayed on the vehicle image displaying field F113 of the screen P11. Further, a pointer is displayed on the pressure value F1141 or the tread depth F1142 of the target tire on the screen P11. Incidentally, when the cancel button B1402 is clicked, the process is terminated at the stage and the screen P11 is displayed.

When a measurement data with a specific transmission ID is received while the screen P14 is displayed on the vehicle image displaying field F113 of the screen P11, the received measurement data is input into the measurement data input field F1403 on the screen P14.

When the OK button B1401 is clicked, the screen P14 of the tread depth or pressure value of the next target tire is automatically displayed. Further, the pointer is displayed on the tread depth F1142 or the pressure value F1141 of the target tire on the measurement record displaying screen P11. Order to input measurement data of one tire is pressure value, inside tread depth, middle tread depth, and outside tread depth. If there are some empty fields when the measurement data of the outside tread depth is input, the fields are input in the above order. Incidentally, when the cancel button B1402 is clicked, the process is terminated at the stage and the screen P11 is displayed.

When the measurement data of the pressure value and the tread depth (inside, middle, outside) of one tire are input, measurement data of a tire whose position is the next in the clockwise direction is input as described above.

When predetermined number of the measurement data has been received, the screen P11 is displayed.

(3) Displayed Measurement Record Saving Function 393

This function is used to identify a measurement record 301 displayed on the screen P11 to save in the database D based on the vehicle code 3031 and the measurement time 3021.

The function 393 is performed based on the following process.

When the save button B1153 is clicked on the screen P11, a measurement record 301 displayed on the screen P11 is saved in the database D.

(4) Data Load Function 394

This function is used to recall and display a measurement record 301 saved in the database D on the screen P11.

The function 394 is performed based on the following process.

When the load button B1152 is clicked while a vehicle code is input in the vehicle code input field F111 on the screen P11, a measurement record 301 corresponding to the vehicle code is searched. When the corresponding measurement record 301 is found, the screen P11 reflecting the corresponding measurement record 301 is displayed. When no corresponding record is found, a message informing it is displayed.

(5) Vehicle/Customer Data Group Editing Function 395

This function is used to edit the vehicle data group 303 and the customer data group 304 displayed on the screen P11.

The function 395 is performed based on the following process.

When the vehicle/customer data group editing button B1121 is clicked on the screen P11, the vehicle/customer data group input screen P12 reflecting the vehicle/customer data group displayed on the screen P11 is displayed, overlapping with the screen P11.

When the vehicle/customer data group is input in the vehicle/customer data group input field F1202 on the screen P12, the input data is displayed in the field F1202. When the OK button B1201 is clicked, the screen P11 reflecting the input data is displayed. Incidentally, when the cancel button B1202 is clicked, the process is terminated at the stage and the screen P11 is displayed.

(6) Tire Data Group Editing Function 396

This function is used to edit respectively each tire data group 305 to 309 displayed on the screen P11.

The function 396 is performed based on the following process.

When the tire data group editing button B1141 of one of the tire data group displaying fields F114 is clicked, the tire data group input screen P13 corresponding to the selected field F114 is displayed, overlapping with the screen P11.

When the tire data group is input into the tire data group input fields F1303 and F1304 on the screen P13, the input data is displayed in the fields F1304 and F1304. When the OK button B1301 is clicked, the screen P11 reflecting the input data in the corresponding field F114 is displayed. Incidentally, when the cancel button B1302 is clicked, the process is terminated at the stage and the screen P11 is displayed.

(7) Measurement Data Editing Function 397

This function is used to edit a measurement data 3052 displayed on the screen P11.

The function 397 is performed based on the following process.

When one of the pressure value F1141 or the tread depth F1142 in one of the tire data group displaying fields F114 is clicked twice by the mouse 322 on the screen P11, the measurement data input screen P14 of the corresponding pressure value or tread depth is displayed on the vehicle image displaying field F113 of the screen P11. Further, a pointer is displayed on the pressure value F1141 or the tread depth F1142 of the target tire on the screen P11. Incidentally, when the cancel button B1402 is clicked on the screen P14, the process is terminated at the stage and the screen P11 is displayed.

When the measurement data is input into the measurement data input field F1403 on the screen P14, the input data is displayed in the field F1403. When the OK button B1401 is clicked, the screen P11 reflecting the input data is displayed. Incidentally, when the cancel button B1402 is clicked, the process is terminated at the stage and the screen P11 is displayed.

(8) Print Function 398

This function is used to:

(a) display a print preview on the display 327 based on a measurement record 301;

(b) input characters in an input field of the print preview by the operator operating the keyboard 321 or the mouse 322; and

(c) print the print preview.

The function 398 is performed based on the following process.

When the print preview displaying button B1154 is clicked on the screen P11, the print preview displaying screen P15 is displayed, overlapping with the screen P11.

When the status displaying field F157 or the comment for customer displaying field F158 is input on the screen P15, the input data is displayed. When the print button B1501 is clicked, the print image displaying field F150 is printed out and the screen P11 is displayed.

(9) Data Export Function 399

This function is used to export a measurement record 301.

The function 399 is performed based on the following process.

When the export destination specifying button B1155 is clicked on the screen P11, the data export executing screen P16 is displayed, overlapping with the screen P11.

When an export destination, a file name at export destination and a file format are input into the export destination input field F1602, the file name input field F1604 and the file format input field F1606 respectively on the screen P16, the input data is displayed. When the OK button B1601 is clicked, the data of the measurement record 301 is exported to the specified export destination, and the screen P11 is displayed. Incidentally, when the cancel button B1602 is clicked, the process is terminated at the stage and the screen P11 is displayed.

Incidentally, since any existing computer software technique can be used for the aforesaid functions and the aforesaid data input screens, detail description will be omitted.

In the aforesaid first embodiment, the measurement data can be obtained and edited, for instance, as follows.

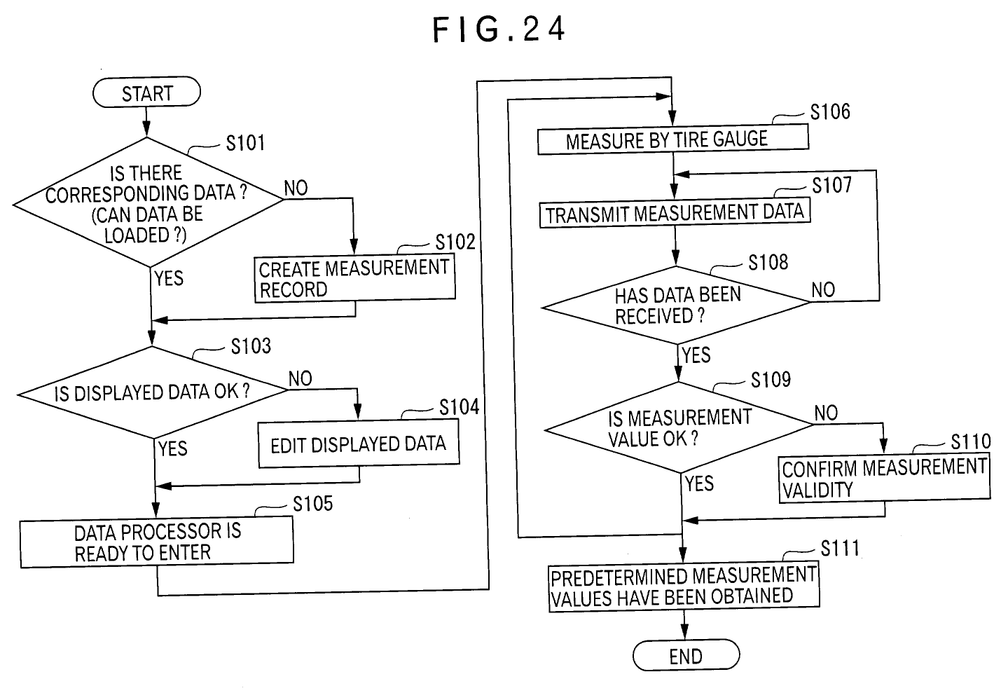

In FIG. 24, an operator operates the computer 32 to check presence of a measurement record 301 of a target vehicle (the measurement record 301 of the corresponding target vehicle is loaded based on the vehicle code 3031) (Step S101).

When there is no corresponding measurement record 301 of the target vehicle in the database D, the operator creates a new measurement record 301 by the computer 32 (Step S102).

The operator checks whether there is a change in the loaded measurement record 301 or whether there is an input error in the new measurement record 301 (Step S103).

When there is any change or any input error, the operator operates the computer 32 to revise the data by the vehicle/customer data group editing function 395 and/or the tire data group editing function 396 (Step S104).

When the operator operates the computer 32 to execute the measurement data input function 392 after the above steps (Step S105), the operator uses the pressure gauge 11 and the depth gauge 12 to measure the tires 21 and 22 (Step S106). When the measurement data is obtained, the operator transmits the measurement data to the data processor 13 (Step S107).

After transmitting one measurement data, the operator checks whether the data processor 13 has received the measurement data (Step S108).

If the measurement data has not been received, the operator transmits the measurement data again (return to Step S107).

If the measurement data has been received, the operator checks whether the measurement data displayed on the computer 32 is acceptable (Step S109).

If the measurement data is abnormal, the operator confirms measurement validity by re-measuring etc. (Step S110).

If the measurement data is acceptable, the operator continues the measurement, i.e. repeats Step S106 to S110 to obtain the measurement data of predetermined number of pressure value and tread depth (inside, middle, outside) (Step S111).

The measurement data can be input and edited, for instance, as the above steps.

Incidentally, the operator can save the input and edited measurement record 301 in the database D whenever the whole measurement record displaying screen P11 is displayed on the computer 32.

After inputting and editing the measurement data, the operator can execute the print function 398 by connecting the computer 32 to the printer 4. Further, the operator can execute the data export function 399 to export the measurement record 301.

Incidentally, the aforesaid steps are examples and it is not necessary to always take the above steps. For example, the tire data groups 305 to 309 can be input before the customer data group 304 is input in the data processor 13.

According to the present embodiment, following effects can be obtained.

(Effect 1) The data processor 3 can process and display the measurement data received from the pressure gauge 11 and the depth gauge 12 on predetermined format without manual transcription by the operator. Accordingly, the need of the conventional manual transcription into the computer can be eliminated.

(Effect 2) The data processor 3 can be in wireless communication with the pressure gauge 11 and the depth gauge 12. Accordingly, no cable will obstruct the operation in measuring. Further, measuring position and location of the data processor 3 are not restricted by cable length limitation.

(Effect 3) The tread depth is measured on three points of inside, middle and outside in width direction of tread surface of tire, so that more precise data to inspect tire condition can be obtained than only one point. Accordingly, the tire condition can be inspected more precisely.

(Effect 4) The data processor 3 displays the measurement data as the colour graph corresponding to the measurement value by the data processor 3, so that length and colour of the graph can be changed corresponding to the tread depth value. Accordingly, the tread depth can be easily determined.

(Effect 5) Data of five tires of one vehicle can be processed together. Accordingly, the tires can be easily compared with each other, so that operation efficiency can be improved.

(Effect 6) Each measurement data is separately transmitted from the tire gauge each time the measurement data is obtained by the tire gauge, and the input order of the measurement data into the data processor 3 is set to an order for the operator to move around the vehicle. Accordingly, it is not necessary for the operator to input the position of the tire each time the tire is measured, so that the operation efficiency can be improved.

(Effect 7) The received measurement data is displayed in a graphic representing the tire position of the vehicle, so that each measurement data can be displayed in association with actual tire positions. Accordingly, the display position of the measurement data can be easily identified. Further, the measurement data of each tire can be easily compared, so that the operation efficiency can be improved.

(Effect 8) The received measurement data is identified based on the transmission ID set to each tire gauge, so that the data processor 3 can determine which tire gauge has transmitted the received data even when receiving the measurement data from a plurality of the tire gauges. Accordingly, interference doesn't occur even when a plurality of the tire gauges are simultaneously used, so that the operation efficiency can be improved.

(Effect 9) The received measurement data is saved in the database including a plurality of measurement data. Accordingly, the received measurement data can be variously utilized for tire maintenance.

(Effect 10) The measurement record is identified with the vehicle registration number and the measurement data/time, so that the vehicle registration number as principal vehicle identification can be used for identifying the data. Accordingly, the database can be easily managed.

(Effect 11) The database includes the measurement data group, the customer data group, the vehicle data group and the tire data group. Accordingly, an ample data can be utilized, so that flexible services can be provided to the customers.

(Effect 12) The measurement data can be printed out with the status information, the comment for customer etc. Accordingly, useful materials for customer service can be made.

(Effect 13) The created data of the measurement record can be exported. Accordingly, the created data of the measurement record can be used in the other software, so that the application range of the measurement record can be extended.

[Second Embodiment]

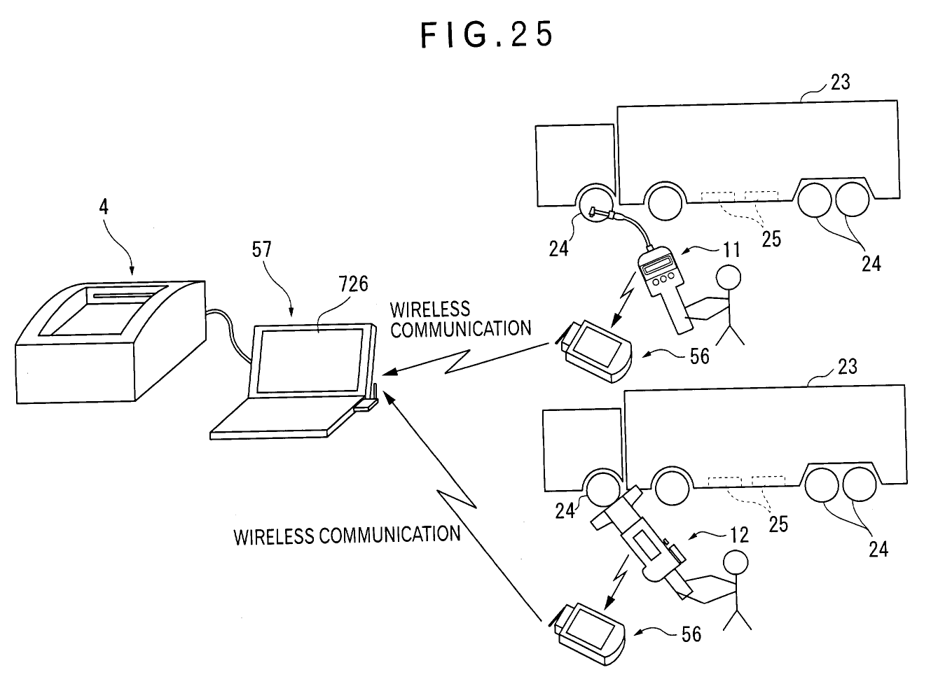

As shown in FIG. 25, a wheel measuring system 50 of the present embodiment has a pressure gauge 11 for measuring air pressure of tires 24 and 25 of trucks 23, a depth gauge 12 for measuring tread depth of the tires 24 and 25, a data logger 56 for receiving data measured by the pressure gauge 11 and the depth gauge 12 and temporally saving the data, and a data storage terminal 57 for receiving, storing and processing the temporally saved data.

The trucks 23 as the measurement object have sixteen tires 24 and two spare tires 25. Each set of four tires 24 is attached to one axle.

Since the pressure gauge 11 and the depth gauge 12 are the same as in the first embodiment, specific description will be omitted.

The data logger 56 including a transceiver receives and temporally saves the measurement data transmitted from the pressure gauge 11 and the depth gauge 12 to transmit the measurement data of one vehicle to the data storage terminal 57 together.

The data storage terminal 57 combines separately input vehicles/customers data with each received data to set a database and displays each measurement data on a display 726. Further, the data storage terminal 57 processes and outputs each data to a colour printer 4. The data storage terminal 57 basically has all functions included in the data processor 13 of the first embodiment.

The data logger 56 will be specifically described first and the data storage terminal 57 will be described second.

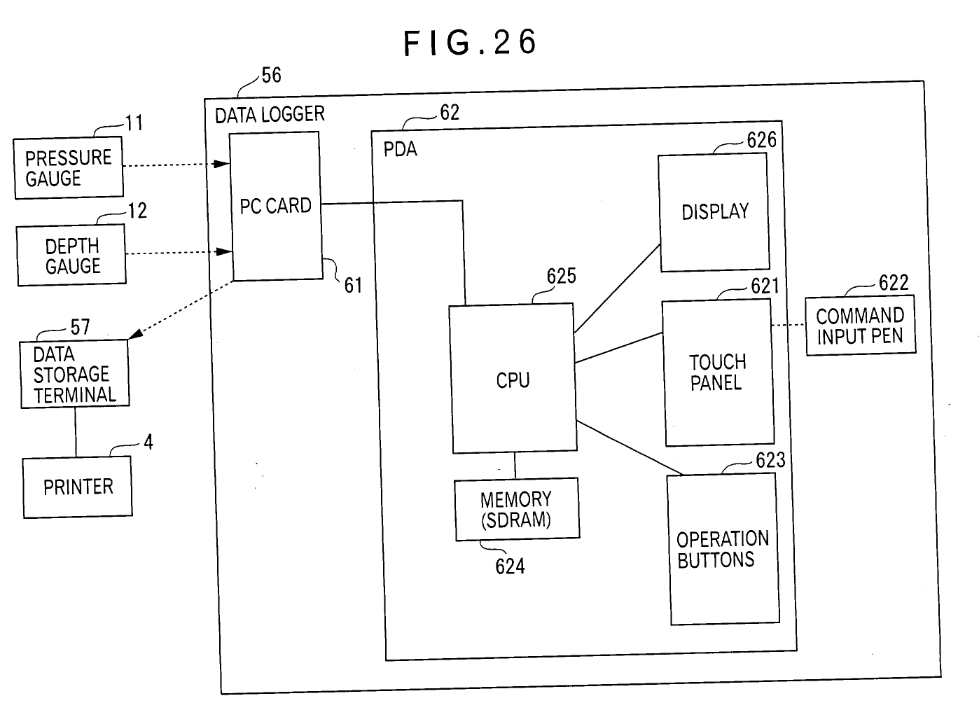

FIG. 26 shows a block diagram of hardware of the data logger 56 of the present embodiment.

The data logger 56 of the present embodiment consists of a PDA (personal digital assistant) 62, into which a PC card (PCMCIA standard card) 61 for receiving the data from the pressure gauge 11 and the depth gauge 12 is inserted.

The PDA 62 temporally saves and transmits the received data to the data storage terminal 57, and has a touch panel 621 to input commands, various data etc., a command input pen 622, operation buttons 623, a SDRAM (Synchronous Dynamic Random Access Memory) 624 as a memory, a CPU 625, and the display 626.

Incidentally, the PDA 62 is commercially available and has a wireless communication function with a commercially available computer.

The measurement data is transmitted, received and saved by a data processing program DP1 run by the CPU 625 of the PDA 62.

A data saving structure DS of the data logger 56 of the present embodiment has measurement records 301A as in the database D of the first embodiment. However, all data can be saved in the measurement records 301A in order to get rid of the reference tables. Data of each measurement record 301A is transmitted to the data storage terminal 57 to store the data therein.

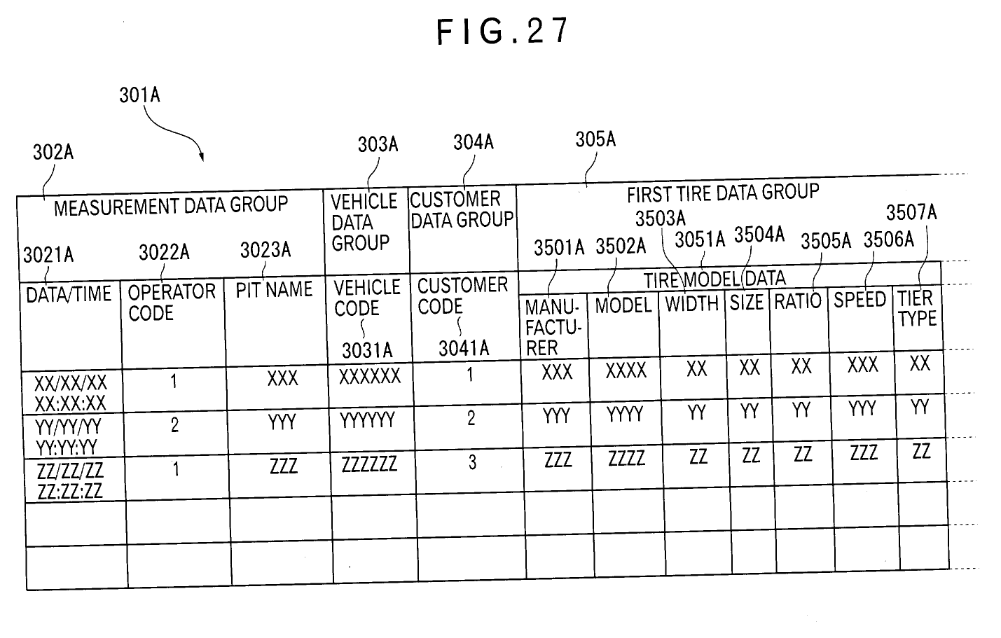

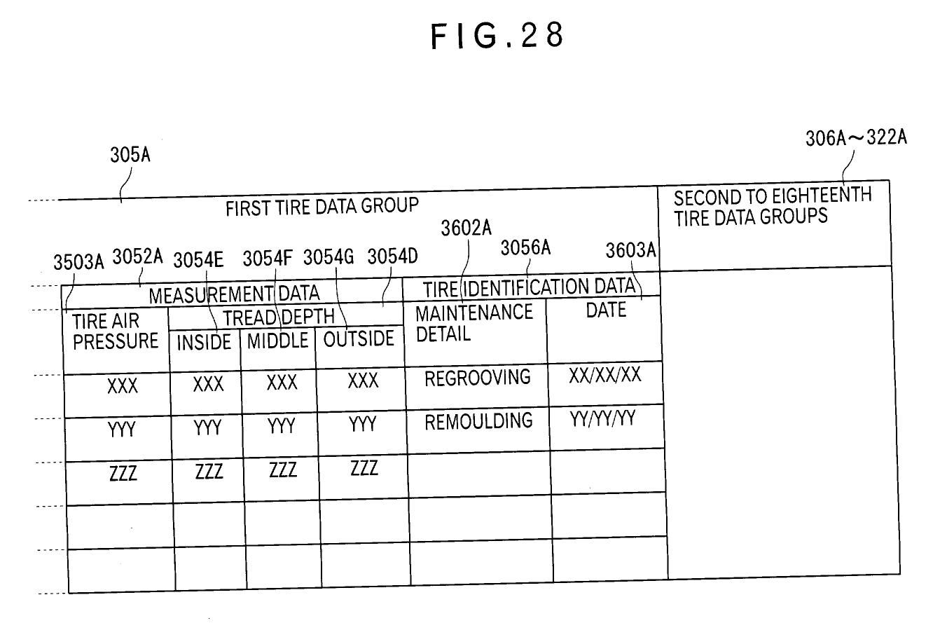

FIG. 27 and FIG. 28 show a specific arrangement of the measurement record 301A of the present embodiment.

The measurement record 301A of the data logger 56 has a measurement data group 302A including a measurement date/time 3021A, an operator code 3022A and a pit name 3023A, a vehicle data group 303A including a vehicle code 3031A, a customer data group 304A including a customer code 3041A, a first data group 305A including a tire model data 3051A, a measurement data 3052A and a tire identification data 3056A, and second to eighteenth tire data groups 306A to 322A including arrangements as in the first tire data group 305A.

The tire model data 3051A has a manufacturer 3501A, a model 3502A, a width 3503A, a size 3504A, a rate 3505A, a speed 3506A and a type 3507A.

The measurement data group 3052A has a tire air pressure 3053A and a tread depth 3054D including an inside tread depth 3054E, a middle tread depth 3054F and an outside tread depth 3054G.

The tire identification data 3056A has a maintenance detail 3602A and a maintenance date 3603A.

Since each element is the same as in the first embodiment, specific description will be omitted.

While the above data saving structure DS is used, the following various data process is performed in the PDA 62 of the present embodiment.

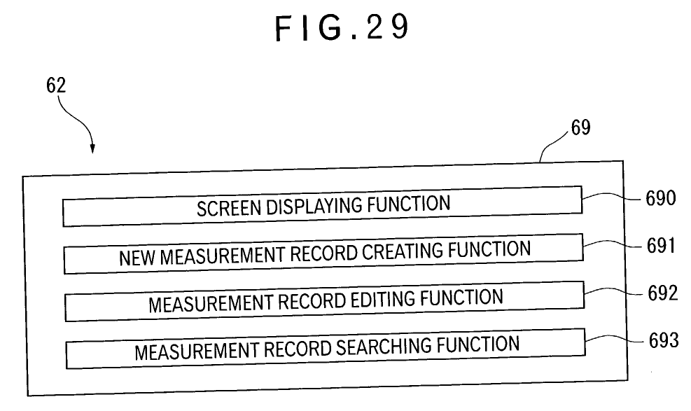

As shown in FIG. 29, a data processing part 69 is loaded on the PDA 62 of the present embodiment by software.

The data processing part 69 has a screen displaying function 690, a new measurement record creating function 691, a measurement record editing function 692 and a measurement record searching function 693.

These functions 690 to 693 are performed by the CPU 625 running a data processing program DPI registered in the SDRAM 624.

The screen displaying function 690 displays some screens on the display 626 under the functions 691 to 693 performed. The display screens are used to input various data or commanding operation to transmit, receive and save the measurement record 301A.

The function 690 has a measurement record list displaying screen P21, a tire position block diagram displaying screen P22, a tire data group input screen P23, and a measurement record searching screen P24. These screens P21 to P24 will be described below.

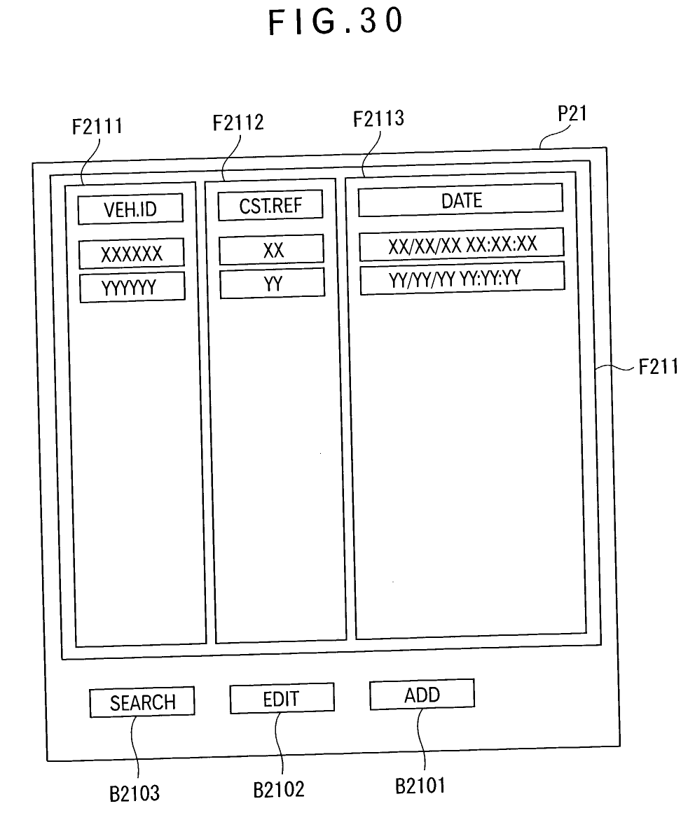

FIG. 30 shows the measurement record list displaying screen P21 for displaying a list of the measurement records 301A.

The screen P21 is displayed on the display 626 when the data processing program DP1 is started, and has a measurement record list displaying field F211, a new record creating button B2101, an edit button B2102 and a search button B2103.

The field F211 vertically displays the measurement records 301A and has a vehicle code displaying field F2111 for vertically displaying vehicle codes 3031A, a customer code displaying field F2112 for vertically displaying customer codes 3041A, and a measurement date/time displaying field F2113 for vertically displaying measurement date/time 3021A. The vehicle code 3031A, the customer code 3041A and the measurement date/time 3021A of each measurement record 301A are horizontally aligned.

Colour of characters and backgrounds thereof of each measurement record 301A are reversed when they are selected by the command input pen 622 or the operation buttons 623.

The button B2101 is used to execute the new record creating function 691. The button B2102 is used to execute the measurement record editing function 693 for selected data in the field F211. The search button B2103 is used to execute the measurement record searching function 693.

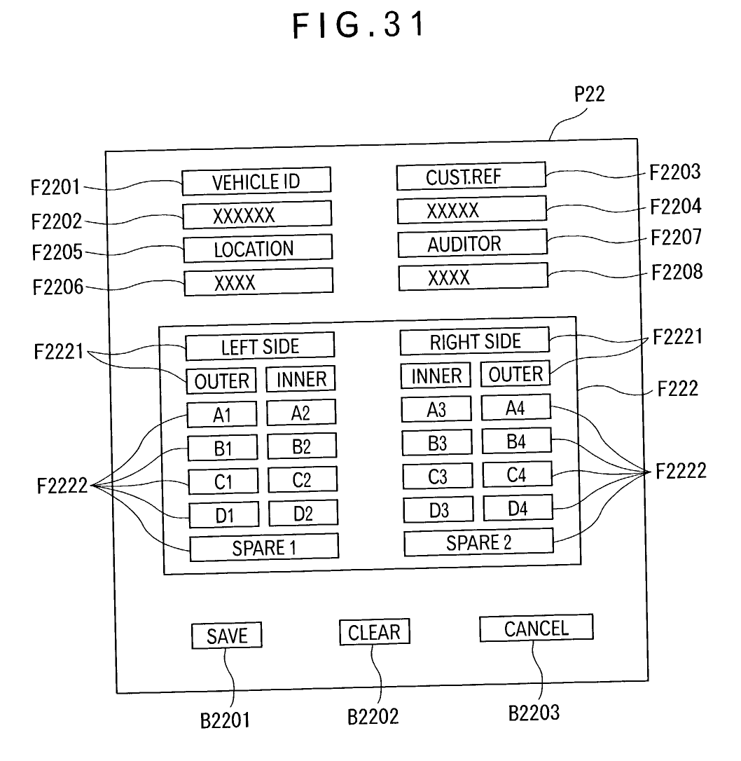

FIG. 31 shows the tire position block diagram displaying screen P22 for displaying a figure showing positions of the tires 24 and 25 of the truck 23.

The screen P22 has a vehicle code displaying field F2201, a vehicle code input field F2202, a customer code displaying field F2203, a customer code input field F2204, a measurement pit name displaying field F2205, a measurement pit name input field F2206, a measuring operator code displaying field F2207, a measuring operator input field F2208, a tire position block diagram F222, a save button B2201, a clear button B2202 and a cancel button B2203.

The field F2201 displays a phrase “VEHICLE ID”. The field F2202 is used to input a vehicle code 3031A. The field F2203 displays a phrase “CUST. REF”. The field F2204 is used to input a customer code 3041A. The field F2205 displays a word “LOCATION”. The field F2206 is used to input a pit name 3023A. The field F2207 displays a word “AUDITOR”. The field F2208 is used to input an operator code 3022A.

The tire position block diagram F222 displays positions of the tires 24 and 25 and has tire position displaying fields F2221 and tire position blocks F2222.

The fields F2221 have words “LEFT SIDE”, “RIGHT SIDE”, “OUTER” and “INNER”. Two sets of the words “OUTER” and “INNER” are displayed below the words “LEFT SIDE” and “RIGHT SIDE” respectively.

The tire position blocks F2222 displays the positions of the tire 24 and 25 and have alphabet characters representing order of the tires 24 attached to the truck 23 from the front, numerical characters representing order of the tires 24 from the left, and representations of spare tire 1 and spare tire 2 for the two spare tires 25.

When the command input pen 622 is touched with one of the tire position blocks F2222, the new measurement record creating function 691 or a part of the measurement record editing function 692 to input and edit the tire data groups 305A to 322A is executed for the selected tire.

When the function 691 is executed, the tire position block F2222 of a current target tire is blinked, and colour of the code and a background thereof of the block F2222 of a tire whose measurement data has been obtained is inverted.

The save button B2201 is used to save the input data. The clear button B2202 is used to clear all of the input fields displayed on the tire block diagram displaying screen P22. The cancel button B2203 is used to terminate the process at the stage.

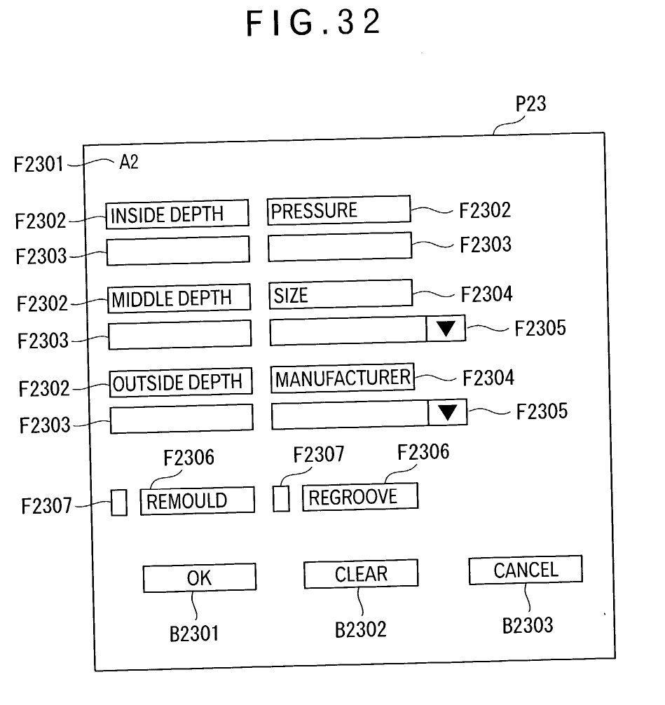

FIG. 32 shows the tire data input screen P23 to input and edit tire data groups 305A to 322A.

The screen P23 has a tire position code displaying field F2301, measurement data displaying fields F2302, measurement data input fields F2303, tire model data displaying fields F2304, tire model input fields F2305, tire identification data displaying fields F2306, tire identification data input fields F2307, an OK button B2301, a clear button B2302 and a cancel button B2303.

The field F2301 displays a code of the tire position block F2222 selected on the screen P22. The fields F2302 display phrases of pressure and tread depth (inside, middle, outside). The fields F2303 are used to input the pressure value and the tread depth (inside, middle, outside). The fields F2304 displays words “SIZE” and “MANUFACTURER”. The fields F2305 are used to input a size and a manufacturer. The fields F2306 displays words “REMOULD” and “REGROOVE”. The fields F2307 are used to input presence of remoulding or regrooving.

Incidentally, each field F2305 can be input by drop menu. Each field F2307 can be input by a check box.

The OK button B2301 is used to temporally save the input data in the SDRAM 624. The clear button B2302 is used to clear all of the input fields displayed on the screen P23. The cancel button B2303 is used to terminate the process at the stage.

The measurement record searching screen P24 (not shown) is used to search a measurement record 301A saved in the SDRAM 624 and has a search word displaying field F2401, a search word input field F2402, a search button B2401 and a cancel button B2402.

The field F2401 displays a phrase “SEARCH WORD”. The field F2402 is used to input a search word. The search button B2401 is used to execute the search function. The cancel button B2402 is used to terminate the process at the stage.

The aforesaid screens P21 to P24 are used to perform following functions 691 to 693 in the data logger 56.

(1) New Measurement Record Creating Function 691

This function is used to create a new measurement record 301A in the SDRAM 624.

The function 691 is performed based on the following process.

When the new record creating button B2102 in the measurement record list displaying screen P21 is clicked, the tire position block diagram displaying screen P22 is displayed.

When a vehicle code 3031A, a customer code 3041A, a pit name 3023A, and an operator code 3022A are input in the vehicle code input field F2202, the customer code input field F2204, the pit name input field F2206 and the operator code input field F2208 respectively on the screen P22, the input data is displayed in the respective input fields F2202, F2204, F2206 and F2208.

When one of the tire position blocks F2222 is selected while at least vehicle code 3031A is input in the field F2202, the tire data group input screen P23 of selected tire position block F2222 is displayed.

Incidentally, when the save button B2201 is clicked on the screen P22, the input data temporally saved in the SDRAM 624 is saved as a measurement record 301A. When the clear button B2202 is clicked, the input data in each input field of the screen P22 is cleared. When the cancel button B2203 is clicked, the process is terminated at the stage and the screen P21 is displayed.

When measurement data, tire model data and tire identification data are input in the measurement data input fields F2303, the tire model data input fields F2305 and the tire identification data input fields F2307 respectively on the tire data group input screen P23, the input data is displayed in the fields F2303, F2305 and F2307. When the measurement data with predetermined transmission ID is received, the data is automatically input into the fields F2303.

When the OK button B2301 is clicked, the input data is temporally saved in the SDRAM 624 and the screen P22 is displayed. When the clear button B2302 is clicked, the input data on the screen P23 is cleared. When the cancel button B2303 is clicked, the process is terminated at the stage and the screen P22 is displayed.

When the OK button B2301 is clicked to display the screen P22, colour of the code and the background thereof of the tire position block F2222, in which the measurement data etc. has been input, is inverted, and the tire position block F2222 of the next target tire is blinked. The next target tire is paired with the measured tire, and when the data input of the pair of the tires is completed, next pair of the tires adjacent to the pair of the measured tires in the counter clockwise direction is measured. Order to measure an inner tire and an outer tire is selectable. For example, when the code A1 is selected first in FIG. 31, the subsequent measurement order is A2, B1, B2, C1, C2 . . .

When data of all the tires has been input by the aforesaid method, colour of the code and the background thereof of all the tire position blocks F2222 is inverted.

(2) Measurement Record Editing Function 692

This function is used to edit a measurement record 301A saved in the SDRAM 624.

The function 692 is performed based on the following process.

When a measurement record 301A in the measurement record list displaying field F211 is selected to edit on the measurement record list displaying screen P21, colour of characters and the background thereof of the vehicle code displaying field F2111, the customer code displaying field F2112 and the measurement date/time displaying field F2113 of the corresponding measurement record 301A is inverted. When the edit button B2102 is clicked in this status, the tire position block diagram displaying screen P22 reflecting the selected measurement record 301A is displayed. Since similar process to the new measurement record creating function 691 is carried out after the above steps except the selected measurement record 301A is reflected, specific description will be omitted.

(3) Measurement Record Searching Function 693

This function is used for searching a measurement record 301A saved in the SDRAM 624.

The function 693 is performed based on the following process.

When the search button B2103 is clicked on the measurement record list displaying screen P21, the measurement record searching screen P24 is displayed.

When a search word is input in the search word input field F2402 on the screen P24, the measurement record 301A including the input search word is searched and displayed on the screen P21. Incidentally, when the cancel button B2402 is clicked, the process is terminated at the stage and the screen P21 is displayed.

Incidentally, since any existing computer software technique can be used for the aforesaid functions and the aforesaid screens, specific description will be omitted.

Since the measurement record 301A is transmitted from the data logger 56 to the data storage terminal 57 by a function included in any existing PDA 62, specific description will be omitted.

Next, the data storage terminal 57 of the present embodiment will be described.

The data storage terminal 57 consists of a notebook computer 72, into which a PC card 71 for receiving data from the data logger 56 is inserted.

The computer 72 saves and processes each received measurement data from the data logger 56, and has the same hardware arrangement as the computer 32 of the first embodiment. Specifically, the computer 72 has a keyboard 721, a mouse 722, a hard disk 723, a CPU 724, a memory 725 and the display 726. Specific description and drawings will be omitted.

Incidentally, the computer 72 is commercially available and configured to communicate with an external device by setting predetermined configuration.

A data processing program DP2 run by the CPU 724 performs various data processing in the computer 72.

Since structure of a database D2 of the present embodiment is basically the same as in the first embodiment, figures and specific description will be omitted.

Incidentally, the second embodiment is different from the first embodiment with respect to having more registration fields for tire data group in a data table following to increase in the number of tires.

While the above database D2 is used, the following various data processing is performed in the present embodiment.

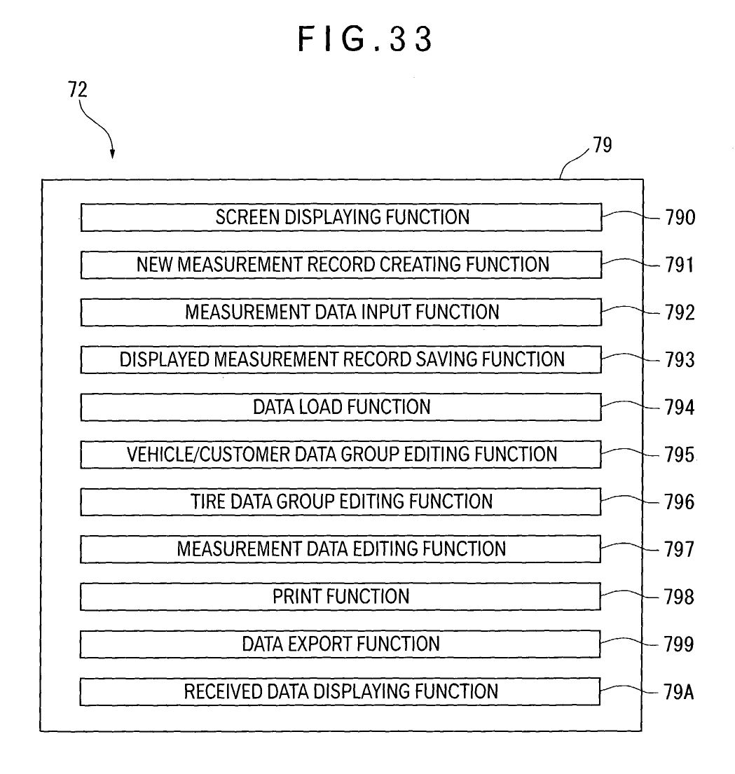

As shown in FIG. 33, a data processing part 79 is loaded on the computer 72 of the present embodiment by software.

The data processing part 79 has a screen displaying function 790, a new measurement record creating function 791, a measurement data input function 792, a displayed measurement record saving function 793, a saved data loading function 794, a vehicle/customer data group editing function 795, a tire data group editing function 796, a measurement data editing function 797, a print function 798, an export function 799 and a received data displaying function 79A.

Since the functions 790 to 799 are the same as the functions 390 to 399 of the data processing part 39 of the first embodiment, specific description will be basically omitted. However, since the screen displaying function 790 is partly different from the screen displaying function 390, description for the function 790 will be supplemented. Further, since the received data displaying function 79A is unique to the data processing part 79, the function 79A will be specifically described below.

The function 790 basically displays the same screens as in the function 390 of the first embodiment. Specifically, the function 790 displays a measurement record displaying screen P31, a vehicle/customer data group input screen P32, a tire data group input screen P33, a measurement data input screen P34, a print preview displaying screen P35 and an export executing screen P36.

Though the aforesaid screens P31 to P3A are basically the same as the screens P11 to P1A of the first embodiment, there is difference based on difference in the number of tires. Accordingly, the measurement record displaying screen P31 and the print preview displaying screen P39 both being remarkably influenced with the difference will be specifically described below, and specific description of the other screens will be omitted.

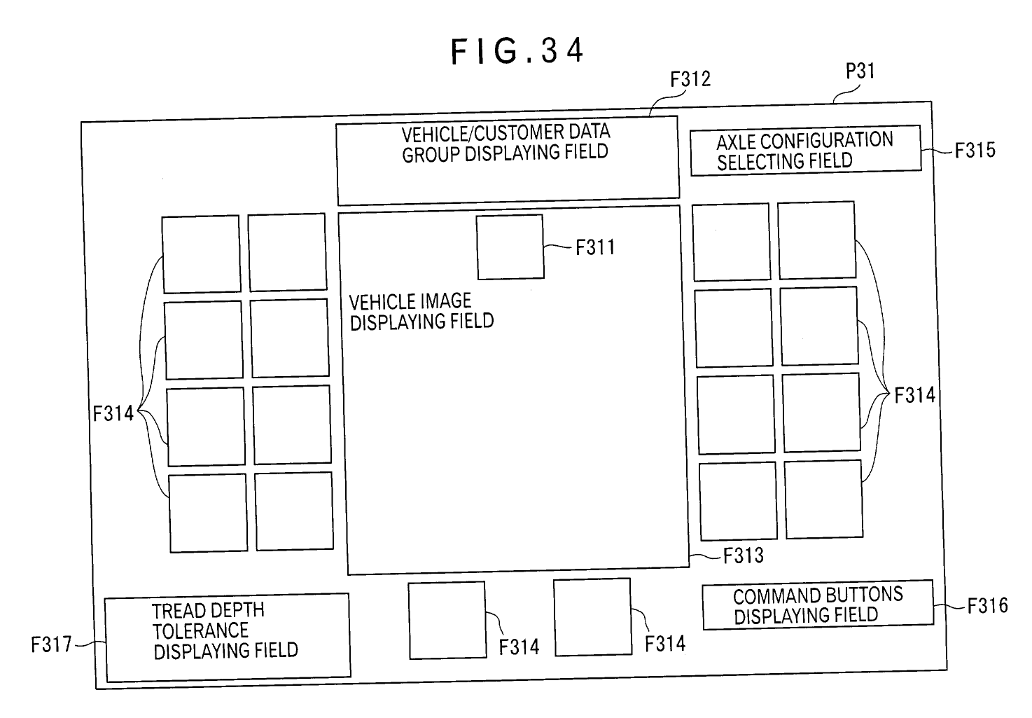

FIG. 34 shows the measurement record displaying screen P31 of the data storage terminal 57 of the present embodiment.

The screen P31 is displayed on the display 726 when the data processing program DP2 is started, and includes a vehicle code displaying field F311, a vehicle/customer data group displaying field F312, a vehicle image displaying field F313, measurement data displaying fields F314, an axle configuration selecting field F315, a command buttons displaying field F316, and a tread depth tolerance value displaying field F317.

Fields having the same functions as in the measurement record displaying screen P11 of the first embodiment will not be specifically described.

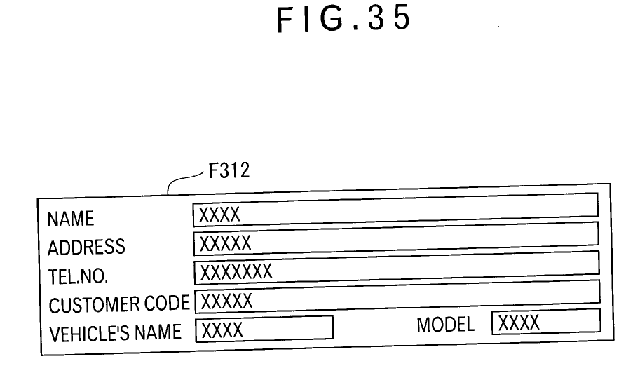

Though the vehicle/customer data group displaying field F312 has similar arrangement to the vehicle/customer data group displaying field F112 of the first embodiment, the field F312 doesn't have the vehicle/customer data group editing button B1121 as shown in FIG. 35.

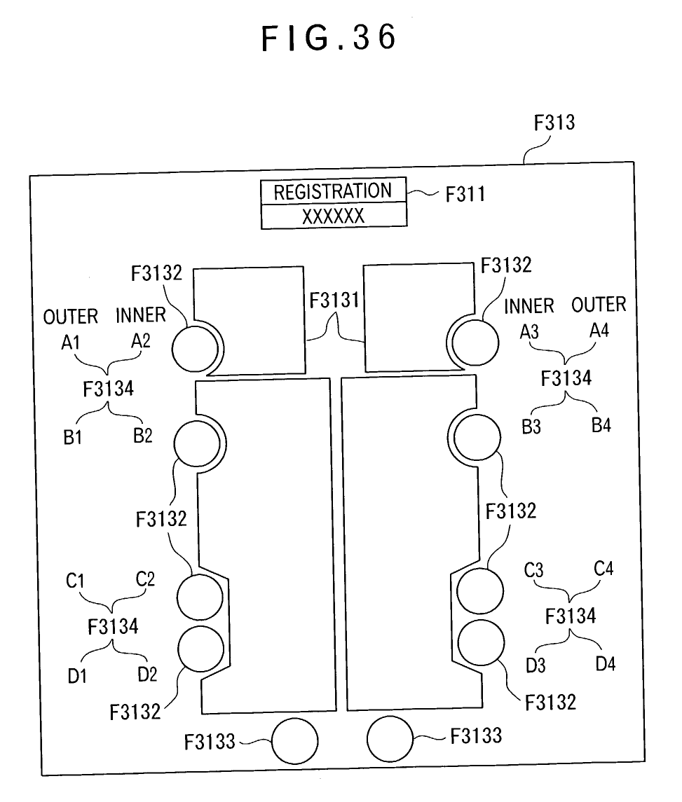

The field F313 is displayed in the centre of the screen and used to display a vehicle image F3131, left and right side tire images F3132, spare tire images F3133 and codes F3134 representing position of each tire as shown in FIG. 36.

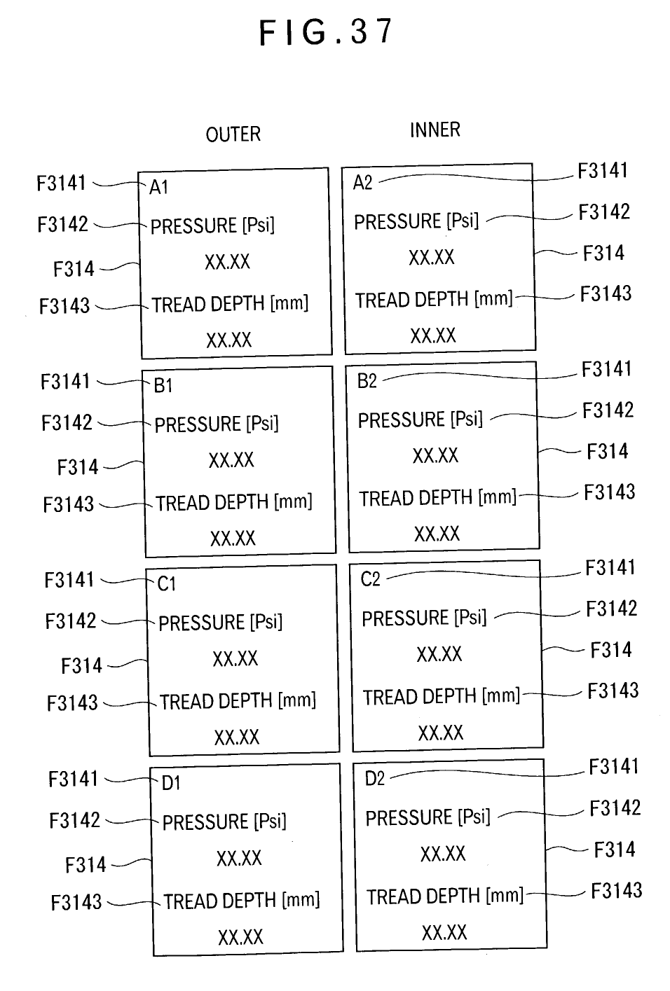

The fields F314 are displayed at eighteen positions, which are on the middle right, on the middle left and in the lower middle of the screen in accordance with the positions of each tire image F3132 and F3133 of the vehicle image displaying field F313. As shown in FIG. 37, each field F314 has a code displaying field F3141 representing position of a tire, a pressure value displaying field F3142 of each tire and a tread depth (minimum value among inside, middle, outside values) displaying field F3143.

Each field F3142 and F3143 has a function as a button for commanding to display the measurement data input screen P34. When each field F3142 or F3143 is clicked twice by the mouse 722, the measurement data input screen P34 of the selected field is displayed.

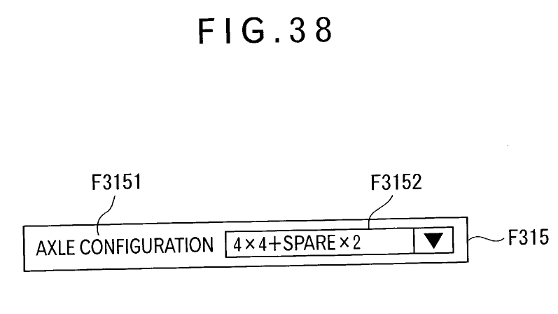

The axle configuration selecting field F315 is displayed on upper right of the screen and includes an axle configuration displaying field F3151 and an axle configuration input field F3152 as shown in FIG. 38. Incidentally, the field F3152 can be input by drop menu.

When an axle configuration of the field F3152 is changed, the vehicle image displaying field F313 and the measurement data displaying fields F314 are changed in response to changing the axle configuration.

The print preview displaying screen P35 (not shown) of the data storage terminal 57 of the present embodiment is different from the print preview displaying screen P15 as in the difference between the measurement record displaying screen P11 of the data processor 13 of the first embodiment and the measurement record displaying screen P31 of the data storage terminal 57 of the second embodiment.

Next, the received data displaying function 79A will be described.

(1) Received Data Displaying Function 79A

This function is used to display received data from the data logger 56 on the measurement record displaying screen P31.

The function 79A is performed based on the following process.

When a measurement record 301A is received from the data logger 56 while the measurement record displaying screen P31 of the data storage terminal 57 is displayed, the received measurement record 301A is displayed on the screen P31 and the database D2 is searched based on the vehicle code 3031A of the received measurement record 301A. If there is the corresponding measurement record 301B in the database D2, the vehicle data group, the tire data group and the customer data group thereof are displayed, which are not included in the measurement record 301A.

Incidentally, since any existing computer software technique can be used for the aforesaid functions 790 to 79A and the aforesaid screens P31 to P3A, specific description will be omitted.

In the second embodiment of the present invention, the measurement data can be obtained, edited and transmitted, for instance, as follows.

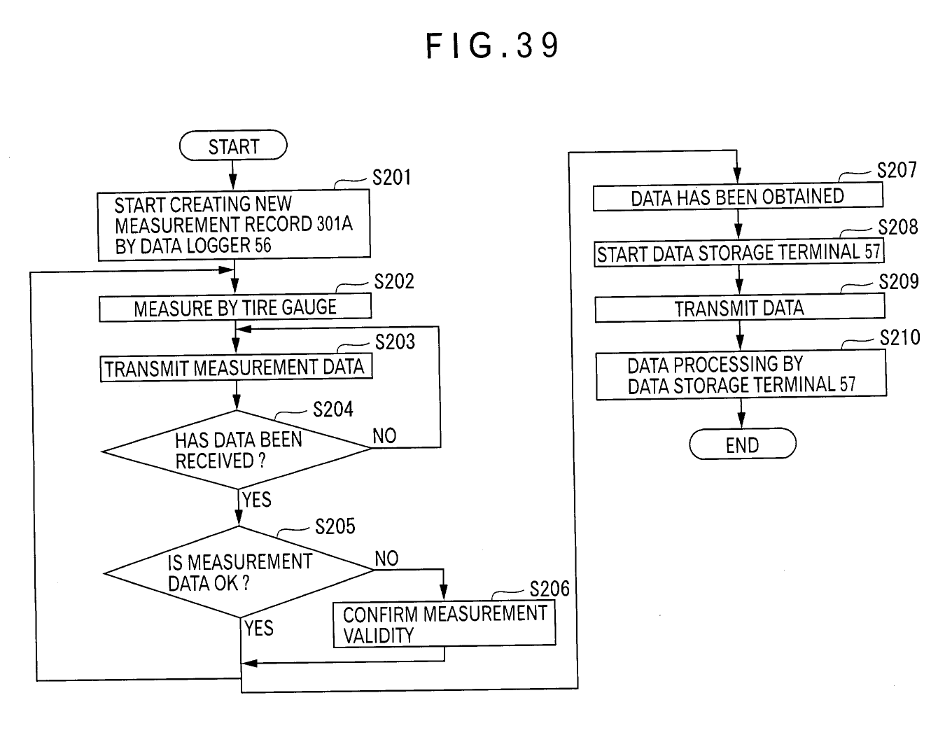

In FIG. 39, an operator starts creating a new measurement record 301A by the data logger 56 (Step S201).

The operator measures the tires 24 and 25 by the pressure gauge 11 and the depth gauge 12 (Step S202), and transmits the measurement data to the data logger 56 when the measurement data is obtained (Step S203).

After transmitting one measurement data, the operator checks whether the data logger 56 has received the measurement data (Step S204).

If the measurement data has not been received, the operator transmits the measurement data again (return to Step S203).

If the measurement data has been received, the operator checks whether the measurement data displayed on the data logger 56 is acceptable (Step S205).

If the measurement data is abnormal, the operator confirms measurement validity by re-measuring etc. (Step S206).

If the measurement data is acceptable, the operator continues the measurement, i.e. repeats Step S202 to S206 for predetermined number of pressure value and tread depth (inside, middle, outside) to finish obtaining measurement data (creating a new measurement record 301A) (Step S207).

The operator starts the data storage terminal 57 (Step S208) and transmits the measurement record 301A from the data logger 56 to the data storage terminal 57 (Step S209).

When the measurement record 301A is received by the data storage terminal 57, data processing such as storing in the database D2, printing or exporting is carried out (Step S210).

According to the present embodiment, the same effects as the effects 1 to 14 (except the effect 4) of the first embodiment can be obtained and a following effect can be obtained.

(Effect 15) The measurement data is temporally saved in the data logger 56 and stored in the database of the data storage terminal 57. Accordingly, the data logger 56 can be portable type, so that mobility can be improved. Further, the data storage terminal 57 is not required to be portable, so that the data storage terminal 57 can be standard desktop type.

[Third Embodiment]

The present embodiment is basically the same as the first embodiment and different with respect to the followings in order to be suitable to promote a replacement component etc. to a customer.

A tire model table 350D (not shown) corresponding to the tire model table 350 of the first embodiment includes data 3051D, 3501D to 3507D respectively corresponding to the data 3051, 3501 to 3507 of the table 350 and further includes price information 3508D of each tire and delivery 3509D of replacing a tire.

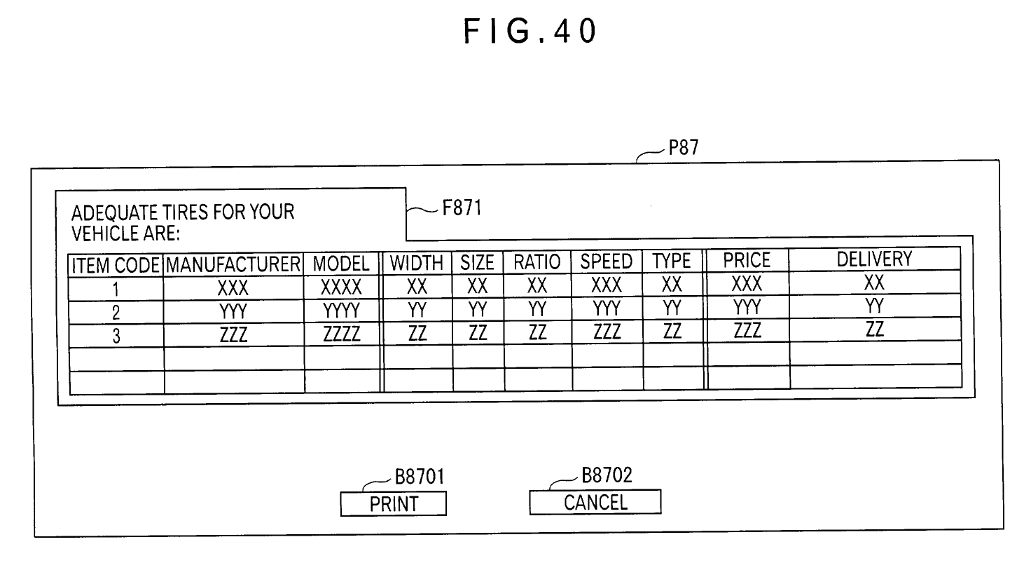

A screen displaying function 890 corresponding to the screen displaying function 390 of the first embodiment includes display screens P81 to P86 (not shown) respectively corresponding to the display screens P11 to P16 of the first embodiment and further includes a replacement tire list displaying screen P87 (FIG. 40) for displaying a list of a suitable replacement tire to the vehicle displayed on the display screen P81.

On the screen P81 corresponding to the screen P11 of the first embodiment, a command buttons displaying field F815 corresponding to the command buttons displaying field F115 has a replacement tire list displaying button B8101 to display the screen P81.

The screen P87 includes a replacement tire list displaying field F871 to display item code, manufacturer, model, width, size, ratio, speed, type, price and delivery of a suitable replacement tire to the vehicle displayed on the screen P81, a print button B8701 to print a replacement tire list 880 for displaying customers displaying data of the field F871 with predetermined data, and a cancel button B8702 to close the display of the screen P81.

The tire list 880 is given to the customer to make a choice at home if a replacement tire cannot be selected on site.

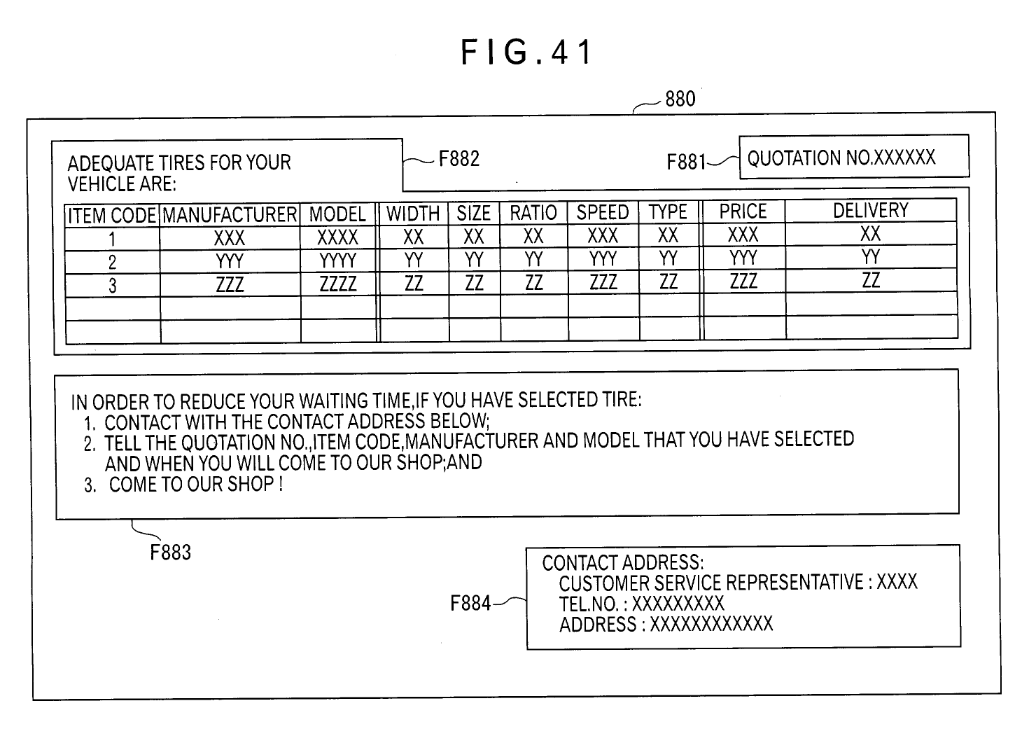

As shown in FIG. 41, the tire list 880 has a quotation number displaying field F881 to display a quotation number, a replacement tire list displaying field F882 to display information of a replacement tire, a customer's procedure displaying field F883 to display customer's order procedure, and a contact address displaying field F884 to display a contact address.

The field F881 shows an identified number to identify the tire list 880.

The field F882 displays data corresponding to the field F871 of the aforesaid screen.

The field F883 shows order procedure for the customer who has taken the tire list 880 and decided to replace a tire. For example, after selecting a replacement tire, the customer should contact with the contact address displayed in the field F884 and tell the quotation number displayed in the field F881, identification data (item code, manufacturer, model) to identify a replacement tire selected from the field F882 and date when the customer comes to the shop. Then, the customer should confirm stock or delivery of the replacement tire and come to the shop.

The present embodiment includes functions 891 to 899 corresponding to the functions 390 to 399 of the data processor 39 of the first embodiment and further includes a replacement tire list displaying function 89A to display a list of a suitable replacement tire to the vehicle displayed on the screen P81.

The function 89A is performed based on the following process.

When the button B8101 is clicked on the screen P81, the screen P87 for a suitable tire list to the vehicle is displayed overlapping with the screen P81.

When the print button B8701 is clicked on the screen P87, the tire list 880 is printed out. When the cancel button B8702 is clicked, the screen P81 is displayed.

Since the third embodiment except the above content is the same with the first embodiment, specific description will be omitted.

According to the present embodiment, the same effects as the effects 1 to 13 of the first embodiment can be obtained and following effects can be obtained further.

(Effect 15) The list of the suitable replacement tire list to the target vehicle can be displayed. Accordingly, even if the operator has a little knowledge of the replacement tire, the business can be smoothly proceeded.

(Effect 16) The replacement tire list includes the delivery information for replacing tire. Accordingly, the business can be preceded furthermore smoothly as more information to decide replacement is provided to the customer.

(Effect 17) The replacement tire list as a document for the customer can be printed out. Accordingly, the customer can take the list to the home without placing the order for the maintenance operation on site, then consider the order later, so that customer service can be improved as providing extra time to consider, and the dealer can increase the possibility of receiving an order later even when the dealer doesn't receive an order on site, so that sales opportunity can be increased.

[Modifications]

Incidentally, the scope of the present invention is not restricted to the above embodiment, but includes modifications and improvements as long as an object of the present invention can be achieved.

For example, although the wireless communication is used as a communication method in the embodiment, radio wave, infrared light etc. can be used as a concrete wireless communication method. Further, not only the wireless communication but also wired communication can be employed.

Although the pressure gauge and the depth gauge as the wheel gauges are used as the measuring instruments in the above embodiment, other wheel gauges such as a hardness tester or a surface roughness gauge can be used, and wheel periphery measuring instruments such as an electronic calliper for measuring a brake pad or a brake shoe and a light permeability test gauge for measuring a brake fluid can be used. Furthermore, the pressure gauge, the depth gauge and the other measuring instruments may be combined together.

When the aforesaid measuring instruments are replaced or added, the present invention can be easily implemented by reflecting replaced or added measurement items to the measurement records, the displayed screens and the operations.

Although the note computers are used as the data processor or the data storage terminal, the computers can be other computer such as a desktop computer. A notebook computer etc. can be used as the data logger instead of the so-called PDA, or the other data input devices such as a specialized input device can be used. However, wide-purpose devices and software may preferably be used to execute the functions of the present invention.

Although the database is set in the data processor, the database can be separated into a database storing device and the data processor as a file server and a processor.

Although the wireless receiver of the data processor is the PCMCIA standard card, an arrangement which the wireless receiver is built-in or which other external device is externally connected through RS232C port or so can be employed.

Although the measurement data is received from the pressure gauge and the depth gauge in turn, the measurement data may be received from only one of them or may be simultaneously received from a plurality of gauges.

Although the measurement data includes the tire pressure and the tread depth of the tire, the measurement data may include other measurement value such as rubber hardness of the tire or surface roughness of the tire. Further, the tire pressure, the tread depth and the other measurement value may be included together.

Although the tread depth is measured on three points of inside, middle and outside in width direction of the tread surface of the tire, the tread depth may be measured on less than or more than three points. Further, points of the tread depth may be processed as data block to display a tread surface profile.

Although the input order of the measurement data into the data processor or the data logger is set in advance, the order may be changed by the operator.

Although the measurement data of the plurality of the tires of one vehicle is displayed on one screen, measurement data of a plurality of tires of a plurality of vehicles may be displayed on one screen.

Although the measurement data is displayed in the figure representing the positions of the tires, the measurement data may be displayed by other method.

Although the bar graph coloured corresponding to the measurement data is displayed, other graph such as a monochrome graph or a circle graph may be displayed.

Although the display screen of the data logger has the input fields, the check boxes and the command buttons in addition to the characters, only text data may be displayed or the same display screen as in the data processor may be displayed.

Although each tire gauge is identified with the transmission ID, channels can be used to identify the tire gauges. Further, the combination of the measuring instrument and the data receiver may be optionally changed.

Although aforesaid embodiment is explained in basis that the number of the tires of the measurement table is restricted, extra tire may be added.

Although the measurement record is identified with the vehicle registration number and the measurement date/time, the measurement data may be identified with other method such as using the customer's name.

Although the measurement record includes the measurement data group, the vehicle data group, the customer data group and the tire data groups, other data may be included or some of the above data groups may be excluded if the measurement data is included.

Although the measurement data is stored in the data processor or the data logger, the measurement data may be stored in the measuring instrument itself.

Although the newly created data or the stored data in the data logger is edited in the data logger, data loaded from the data storage terminal may be used in the data logger.

Although the maintenance operation is the replacement of the tire, the maintenance operation may be other operation such as replacement of a brake pad.

Although the data for the replacement tire includes the item code, the manufacturer, the model, the width, the size, the ratio, the speed, the type, the price and the delivery information for replacing the tire, the data for the replacement tire may include other promotion information such as features of each replacement tire or an image of tread pattern of each replacement tire.

What is claimed is:

1. A wheel measurement system, comprising:
a wheel gauge having a measurement portion for measuring predetermined maintenance data on a wheel attached to a vehicle and the periphery thereof, and a transmitter for transmitting the measurement data; and
a data processor having a receiver for receiving the measurement data from the wheel gauge and a data displaying portion for processing and displaying the received measurement data in a predetermined form.

2. A data processor, comprising:
a receiver for receiving measurement data on a wheel attached to a vehicle and the periphery thereof from a wheel gauge for measuring predetermined maintenance data on the wheel and the periphery; and
a data displaying portion for processing and displaying the received measurement data in a predetermined form.

3. The data processor according to claim 2, wherein the received measurement data includes at least one of pressure value of a tire of the wheel, tread depth of the tire and a pad wear of a brake provided to the periphery of the wheel.

4. The data processor according to claim 3, wherein the tread depth of the tire is measured on at least three points of inside, middle and outside in width direction of a tread surface of the tire.

5. The data processor according to claim 2, wherein the data displaying portion displays a graph coloured corresponding to a selected measurement value.

6. The data processor according to claim 2, wherein the measurement data on the wheel and the periphery includes data on a plurality of wheels of one vehicle and the periphery thereof.

7. The data processor according to claim 6, wherein the measurement data includes data on a spare tire loaded on the vehicle as well as the data on the plurality of wheels of one vehicle and the periphery thereof.

8. The data processor according to claim 6, wherein the measurement data from the wheel gauge is transmitted in segment of each wheel or of each wheel and spare tire; and
wherein the data on the wheel and the periphery or on the wheel, the periphery and the spare tire is input into the data displaying portion in an order for an operator to move around a vehicle.

9. The data processor according to claim 6, wherein the received measurement data is displayed in graphic representing positions of wheels or wheels and a spare tire in a vehicle.

10. The data processor according to claim 2, wherein the receiver can communicate with a plurality of wheel gauges, and the received measurement data is identified by a transmission identification set to each wheel gauge.

11. The data processor according to claim 2, wherein the received measurement data is registered in a database including a plurality of measurement records.

12. The data processor according to claim 11, wherein each measurement record is identified by a vehicle registration number and measurement date/time.

13. The data processor according to claim 11, further comprising:
a data logger having a receiver for receiving the measurement data from the wheel gauge and temporally storing the received measurement data, and a data storage terminal independent of the data logger for storing the temporally stored measurement data transmitted from the data logger in the database.

14. A wheel measuring method, comprising:
providing a wheel measurement system including a wheel gauge for measuring predetermined maintenance data on a wheel and the periphery thereof, and a data processor having a receiver for receiving measurement data on the wheel and the periphery and a data displaying portion for processing and displaying the measurement data on the wheel and the periphery in a predetermined form;
obtaining the measurement data on a wheel attached to a vehicle and the periphery thereof by an operator using the wheel gauge;
transmitting the measurement data from the wheel gauge to the data processor; and
processing and displaying the transmitted measurement data by the data processor in a predetermined form.

15. The wheel measuring method according to claim 14, wherein the transmitted measurement data includes at least one of pressure value of a tire of the wheel, tread depth of the tire and a pad wear of a brake provided to the periphery of the wheel.

16. The wheel measuring method according to claim 15, wherein the tread depth of the tire is measured on at least three points of inside, middle and outside in width direction of a tread surface of the tire.

17. The wheel measuring method according to claim 14, wherein the data displaying portion displays a graph coloured corresponding to a selected measurement value.

18. The wheel measuring method according to claim 14, wherein the transmitted measurement data includes data on a plurality of wheels of one vehicle and the periphery thereof.

19. The wheel measuring method according to claim 18, wherein the measurement data includes data on a spare tire loaded on the vehicle as well as the data on the plurality of wheels of one vehicle and the periphery thereof.

20. The wheel measuring method according to claim 18, further comprising:
transmitting the measurement data from the wheel gauge in segment of each wheel or of each wheel and spare tire; and
inputting the transmitted data into the data displaying portion in an order for an operator to move around a vehicle.

21. The wheel measuring method according to claim 18, further comprising the step of:
displaying the transmitted measurement data in a graphic representing positions of wheels or wheels and a spare tire in a vehicle.

22. The wheel measuring method according to claim 14, wherein the system includes a plurality of wheel gauges,
the method further comprising the step of setting a transmission identification for each wheel gauge to the measurement data before transmission to identify each transmitted measurement data.

23. The wheel measuring method according to claim 14, further comprising the step of:
storing the transmitted measurement data in a database including a plurality of measurement records.

24. The wheel measuring method according to claim 23, wherein each transmitted measurement data is stored as the measurement record, which is identified by a vehicle registration number and measurement date/time.

25. The wheel measuring method according to claim 23, wherein the data processor includes a data logger and a data storage terminal, the data logger having a receiver for receiving the measurement data from the wheel gauge and temporally storing the transmitted measurement data, and the data storage terminal independent of the data logger for storing the temporally stored measurement data transmitted from the data logger in the database; and
the method further comprising temporally storing the measurement data from the wheel gauge in the data logger; and
storing the temporally stored measurement data transmitted from the data logger in the data storage terminal.

26. A program for a computer system to perform the wheel measuring method according to claim 14.

27. A recording medium that stores a program for a computer system to perform the wheel measuring method according to claim 14.

28. A wheel-related product sales method, comprising:
setting a database to which predetermined maintenance data on a wheel attached to a vehicle and the periphery thereof is registered in advance;
measuring the maintenance data from a wheel of a vehicle as a measurement object and the periphery thereof to be registered in the database;
forecasting maintenance operation timing of the wheel and the periphery on the basis of the measured maintenance data; and
selecting and displaying recommended maintenance operation for the vehicle with price information to offer the maintenance operation to the owner of the vehicle.

29. The wheel-related product sales method according to claim 28, wherein delivery time of the maintenance operation can be displayed in addition to the price information.

30. The wheel-related product sales method according to claim 28, wherein the maintenance data includes replacement timing of a replacement component for the wheel or the periphery thereof and price of the replacement component; and
wherein the maintenance operation is to replace the replacement component.

31. The wheel-related product sales method according to claim 28, wherein the wheel has a tire and the periphery of the wheel has a brake pad; and
wherein the maintenance data includes at least one of air pressure of the tire or the tread depth of the tire or thickness of the brake pad.

32. The wheel-related product sales method according to claim 31, wherein maintenance operation timing of the tire is determined based on the tread depth thereof.

33. The wheel-related product sales method according to claim 31, wherein maintenance operation timing of the brake pad is determined based on pad wear thereof.
